(19) United States
(12) Patent Application Publication
(10) Pub. No.: US 2013/0332435 A1
(43) Pub. Date: Dec. 12, 2013

(54) PARTITIONING OPTIMISTIC CONCURRENCY CONTROL AND LOGGING

(71) Applicants: Philip A. Bernstein, Bellevue, WA (US); Sudipto Das, Bellevue, WA (US)

(72) Inventors: Philip A. Bernstein, Bellevue, WA (US); Sudipto Das, Bellevue, WA (US)

(73) Assignee: MICROSOFT CORPORATION, Redmond, WA (US)

(21) Appl. No.: 13/494,876

(22) Filed: Jun. 12, 2012

(51) Int. Cl. G06F 17/30

(52) U.S. Cl. 707/703; 707/E17.005

(57) ABSTRACT

Parallel certification of transactions on shared data stored in database partitions included in an approximate database partitioning arrangement may be initiated, based on initiating a plurality of certification algorithm executions in parallel, and providing a sequential certifier effect. Logging operations associated with a plurality of log partitions configured to store transaction objects associated with each respective transaction may be initiated, each respective database partition included in the approximate database partitioning being associated with one or more of the log partitions. A scheduler may assign each of the transactions to a selected one of the certification algorithm executions.

### BACKGROUND

Users of electronic devices frequently access systems in which data is shared among many users and/or processes. If transactions are processed on the shared data, conflicts of operations may lead to unpredictable and unreliable results. For example, if one user is updating information as other users are reading the information, then the readers may each receive different results, based on the order of each user's accesses to the information. As another example, multiple users may be updating shared data in parallel, which may provide different results, depending on the order of execution of modifications made by the various users.

### SUMMARY

According to one general aspect, a system may include a certification component configured to initiate certification, in parallel, of transactions on shared data stored in database partitions included in an approximate database partitioning arrangement. The certification may be based on initiating a plurality of certification algorithm executions in parallel, and may provide a sequential certifier effect. The system may also include a log management component configured to initiate logging operations associated with a plurality of log partitions configured to store transaction objects associated with each respective transaction. Each respective database partition included in the approximate database partitioning may be associated with one or more of the log partitions. The system may also include a scheduler configured to assign each of the transactions to a selected one of the certification algorithm executions.

According to another aspect, logging operations associated with a plurality of log partitions configured to store transaction objects associated with transactions on shared data stored in database partitions included in an approximate database partitioning arrangement may be initiated. Each respective database partition included in the approximate database partitioning may be associated with one or more of the log partitions. The logging operations may be based on mapping the transaction objects to respective log partitions corresponding to respective database partitions accessed by respective transactions associated with the respective mapped transaction objects. The transaction objects may be associated with transaction certification ordering attributes. Certification of the transactions on the shared data stored in the database partitions may be initiated. The certification may be based on receiving certification requests from a scheduler, based on the transaction certification ordering attributes, based on accessing the transaction objects stored in the log partitions, in an ordering of storage in the respective log partitions.

According to another aspect, a computer program product tangibly embodied on a computer-readable storage medium may include executable code that may be configured to cause at least one data processing apparatus to assign each of a plurality of transactions on shared data, stored in database partitions included in an approximate database partitioning arrangement, to respective selected ones of a plurality of certification algorithm executions. Further, the at least one data processing apparatus may initiate certification, in parallel, of the transactions on the shared data stored in the database partitions. The certification may be based on initiating the plurality of certification algorithm executions in parallel, and may provide a sequential certifier effect.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings, and from the claims.

### DRAWINGS

FIG. 1 is a block diagram of an example system for certifying transactions on shared data in a partitioned database.

FIG. 2 is a flowchart illustrating example operations of the system of FIG. 1.

FIG. 3 is a flowchart illustrating example operations of the system of FIG. 1.

FIG. 4 is a flowchart illustrating example operations of the system of FIG. 1.

FIG. 5 depicts example structures of transaction processing systems with an approximate database partitioning.

FIG. 6 depicts a parallel certifier indicating example variables and data structures

FIG. 7 depicts an example processing of a single-partition transaction by a parallel certifier.

FIG. 8 illustrates an example processing of single-partition transactions.

FIG. 9 illustrates an example processing of a multi-partition transaction.

FIG. 10 illustrates an example processing of an example single-partition transaction.

FIG. 11 illustrates an example processing of an example single-partition transaction.

FIG. 12 illustrates example processing by a parallelized certifier.

FIG. 13 illustrates example processing by a parallelized certifier.

FIG. 14 illustrates parallelization of processing of multi-partition transactions across certifiers corresponding to the partitions that the transaction accessed.

FIG. 15 illustrates example log sequence numbers used in an example partitioned log design.

FIG. 16 illustrates single-partition transactions that are appended to logs corresponding to the partitions where the transactions accessed data.

FIG. 17 illustrates an example multi-partition transaction.

FIG. 18 illustrates single-partition transactions that follow a multi-partition transaction.

FIG. 19 illustrates processing of an example multi-partition transaction.

FIG. 20 illustrates an example append of a next single-partition transaction to a log.

FIG. 21 illustrates an example partitioning of a database in accordance with Hyder.

### DETAILED DESCRIPTION

Optimistic concurrency control (OCC) is a technique for analyzing transactions that access shared data to determine which transactions may commit and which may abort (e.g., due to conflicts). Instead of synchronizing transactions as they are executed (e.g., using locks), a system using OCC may allow transactions to execute without synchronization. After a transaction terminates, for example, an OCC algorithm may determine whether the transaction will be allowed to commit, or will be aborted (e.g., via backup).

Example techniques discussed herein may provide a “certifier” (e.g., as a component of a system) that uses OCC to determine whether a transaction committed or aborted by analyzing descriptions of transactions one-by-one in a given total order. According to an example embodiment, each transaction description, which may be referred to herein as an “intention,” may be represented as a record that describes the operations that the transaction performed on shared data, such as read and/or write operations. According to an example embodiment, the sequence of intentions may be stored in a log. According to an example embodiment, a certifier algorithm may analyze intentions in the order in which they appear in the log, which is also the order in which the transactions executed.

There may exist limits on speed for appending intentions to a single log and on speed for certifying intentions (e.g., certifying transactions). For example, such limits may be imposed by the underlying hardware, such as the maximum throughput of a storage sub-system and a central processing unit (CPU) clock speed. Such constraints may thus limit the scalability of a system that uses a single log and certifies intentions sequentially. To improve the throughput, example techniques discussed herein may provide parallelized certifier algorithms and partitioned logs. For example, if the certifier can be parallelized, then independent processors may execute the algorithm on a subset of the intentions in the log sequence. For example, if the log can be partitioned, then it may be distributed over independent storage devices to provide higher aggregate throughput of read and append operations to the log.

According to example embodiments discussed herein, a database partitioning may be described via a set of partition names, such as {P₁, P₂, . . . }, and an assignment of every data item in a database to no more than one of the partitions. In this context, a partitioning technique may be referred to as “approximate” if a subset of transactions access two or more partitions. As discussed further herein, given an approximate database partitioning technique, the certifier may be parallelized and the log may be partitioned. Such example techniques may, for example, improve the overall system throughput while preserving transaction correctness semantics equivalent to a single log and a sequential certifier.

More formally, given an approximate database partitioning P={P₁, P₂, . . . , Pₙ} and a certification algorithm (C), example techniques discussed herein may parallelize C into n+1 parallel executions {C₀, C₁, C₂, . . . , Cₙ} where {C₁, C₂, . . . , Cₙ} may certify single-partition transactions corresponding to their partition, and C₀ may certify multi-partition transactions. A scheduler S may assign each incoming transaction to an appropriate certifier along with a synchronization constraint that may ensure that each pair of transactions that access the same partition are processed in the order in which they appear in the log.

Additionally, given an algorithm to atomically append entries to a log(L), example techniques discussed herein may partition the log into n+1 distinct logs L={L₀, L₁, L₂, . . . , Lₙ}, where {L₁, L₂, . . . , Lₙ} are associated with the database partitions and L₀ is associated with multi-partition transactions. Example techniques discussed herein may sequence the logs so that every pair of transactions appears in the same relative order in all logs in which they both appear.

As used herein, an operation may be “atomic” if the whole operation is performed with no interruption or interleaving from any other process. For example, an atomic operation is an operation that may be executed without any other process being able to read or change state that is read or changed during the operation. For example, an atomic operation may be implemented using an example atomic “compare and swap” (CAS) instruction, or an example atomic test-and-set (TS) operation.

According to example embodiments discussed herein, a certifier may be parallelized relative to a given approximate database partitioning.

According to example embodiments discussed herein, constraints may be determined such that the parallel certifiers provide a same effect as a sequential certifier.

According to example embodiments discussed herein, the certification of each multi-partition transaction may be parallelized by distributing its certification actions to the certifiers of the partitions accessed by the transaction.

According to example embodiments discussed herein, given an approximate database partitioning and a technique to atomically append an intention to a log, the log may be partitioned.

According to example embodiments discussed herein, a partial order may be established on the set of all intentions across all logs.

According to example embodiments discussed herein, an ordering may be established wherein every pair of transactions appears in the same relative order in all logs in which they both appear.

According to example embodiments discussed herein, the partitioned log may be implemented with a sequential certifier as well as a parallel certifier. According to example embodiments discussed herein, the parallel certifier may be implemented with a single log as well as a partitioned log.

According to example embodiments discussed herein, parallel certifiers and/or partitioned logs may be used to scale-out a transaction processing database.

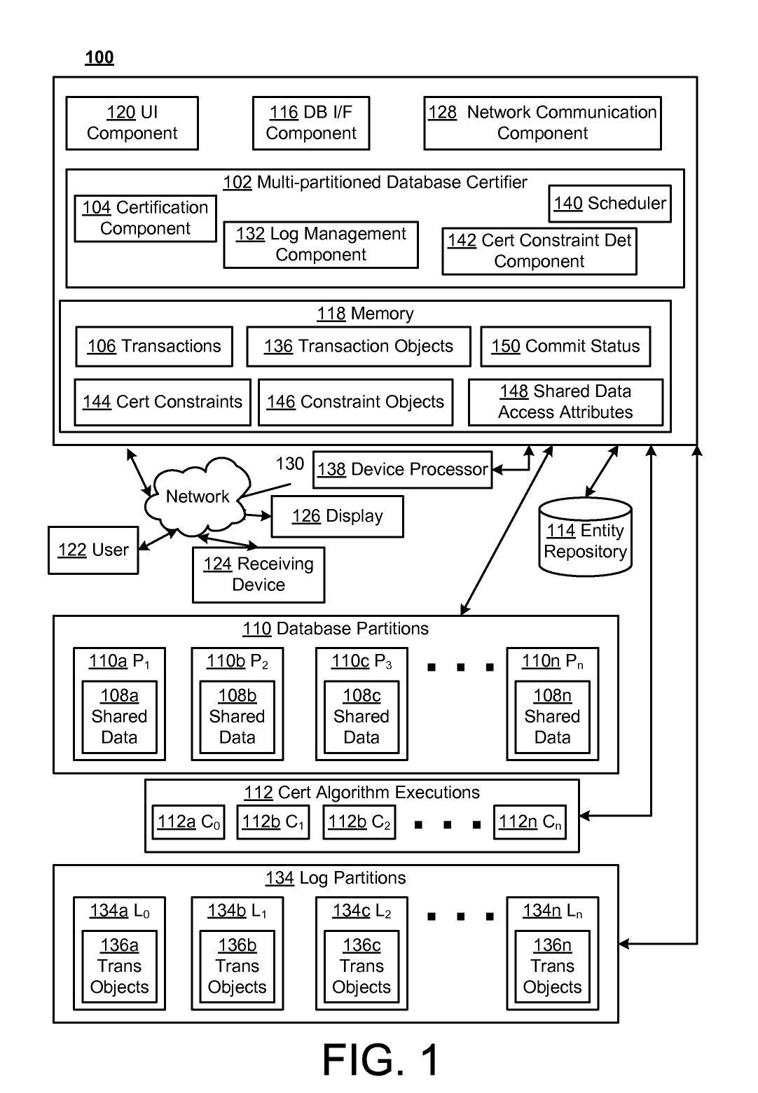

As further discussed herein, FIG. 1 is a block diagram of a system 100 for certifying transactions on shared data in a partitioned database. As shown in FIG. 1, a system 100 may include a multi-partitioned database certifier 102 that includes a certification component 104 that may be configured to initiate certification, in parallel, of transactions 106 on shared data 108 stored in database partitions 110 included in an approximate database partitioning arrangement. The certification may be based on initiating a plurality of certification algorithm executions 112 in parallel, and may provide a sequential certifier effect. For example, the database partitions 110 may be located on a single machine or computing device, or may be located on multiple devices, and may be accessed via one or more networks. For example, the certification algorithm executions 112 may be co-located on machines or computing devices with the database partitions 110, or may be located on a separate machine or multiple machines or computing devices.

According to an example embodiment, the multi-partitioned database certifier 102, or one or more portions thereof, may include executable instructions that may be stored on a computer-readable (or computer-usable) storage medium, as discussed below. According to an example embodiment, the computer-readable (or computer-usable) storage medium may include any number of storage devices, and any number of storage media types, including distributed devices.

For example, an entity repository 114 may include one or more databases, and may be accessed via a database interface component 116. One skilled in the art of data processing will appreciate that there are many techniques for storing repository information discussed herein, such as various types of database configurations (e.g., relational databases, hierarchical databases, distributed databases) and non-database configurations.

According to an example embodiment, the multi-partitioned database certifier 102 may include a memory 118 that may store the transactions 106 (e.g., during processing by the multi-partitioned database certifier 102). In this context, a “memory” may include a single memory device or multiple memory devices configured to store data and/or instructions. Further, the memory 118 may span multiple distributed storage devices.

According to an example embodiment, a user interface component 120 may manage communications between a user 122 and the multi-partitioned database certifier 102. The user 122 may be associated with a receiving device 124 that may be associated with a display 126 and other input/output devices. For example, the display 126 may be configured to communicate with the receiving device 124, via internal device bus communications, or via at least one network connection.

According to example embodiments, the display 126 may be implemented as a flat screen display, a print form of display, a two-dimensional display, a three-dimensional display, a static display, a moving display, sensory displays such as tactile output, audio output, and any other form of output for communicating with a user (e.g., the user 122).

According to an example embodiment, the multi-partitioned database certifier 102 may include a network communication component 128 that may manage network communication between the multi-partitioned database certifier 102 and other entities that may communicate with the multi-partitioned database certifier 102 via at least one network 130. For example, the at least one network 130 may include at least one of the Internet, at least one wireless network, or at least one wired network. For example, the at least one network 130 may include a cellular network, a radio network, or any type of network that may support transmission of data for the multi-partitioned database certifier 102. For example, the network communication component 128 may manage network communications between the multi-partitioned database certifier 102 and the receiving device 124. For example, the network communication component 128 may manage network communication between the user interface component 120 and the receiving device 124.

A log management component 132 may be configured to initiate logging operations associated with a plurality of log partitions 134 configured to store transaction objects 136 associated with each respective transaction 106. Each respective database partition 110 included in the approximate database partitioning may be associated with one or more of the log partitions 134. According to an example embodiment, the transaction objects 136 may also be stored in the memory 118 (e.g., during processing by the multi-partitioned database certifier 102).

According to an example embodiment, the operations discussed herein may be processed via one or more device processors 138. In this context, a “processor” may include a single processor or multiple processors configured to process instructions associated with a processing system. A processor may thus include one or more processors processing instructions in parallel and/or in a distributed manner. Although the device processor 138 is depicted as external to the multi-partitioned database certifier 102 in FIG. 1, one skilled in the art of data processing will appreciate that the device processor 138 may be implemented as a single component, and/or as distributed units which may be located internally or externally to the multi-partitioned database certifier 102, and/or any of its elements.

A scheduler 140 may be configured to assign each of the transactions 106 to a selected one of the certification algorithm executions 112.

According to an example embodiment, the plurality of log partitions 134 may include a multi-database-partition log partition 134a configured to store transaction objects 136a associated with respective ones of the transactions 106 that access shared data 108 that is stored in a plurality of the database partitions 110, and a set of single-database partition log partitions 134b-134n. Each of the single-database partition log partitions 134b-134n may be configured to store transaction objects 136b-136n associated with respective ones of the transactions 106 that access shared data 108 that is stored in a single associated one of the database partitions 110.

According to an example embodiment, each one of the transaction objects 136 may include a transaction description that includes one or more indicators associated with descriptions of operations performed by the respective transaction on the shared data. For example, the transaction descriptions may include “intentions” as discussed further herein.

According to an example embodiment, each one of the certification algorithm executions 112 may be configured to sequentially analyze the descriptions of the operations performed by respective transactions 106 assigned to the certification algorithm executions 112, in an order in which the descriptions of the operations are stored in an associated log partition 134. The analysis may be based on determining conflicts between pairs of the descriptions of the operations.

According to an example embodiment, determining conflicts between pairs of the descriptions of the operations may include one or more of determining whether a relative order in which the operations associated with the descriptions execute modifies a value of a shared data item, or determining whether a relative order in which the operations associated with the descriptions execute affects a value returned by one of the operations associated with the descriptions.

According to an example embodiment, a certification constraint determination component 142 may be configured to determine certification constraints 144 indicating certification ordering of sets of the transactions 106, based on determining database partition accesses associated with respective ones of the transactions 106.

According to an example embodiment, the scheduler 140 may be configured to assign each of the transactions 106 and associated constraint objects 146 to the selected one of the certification algorithm executions 112, based on retrieving stored transaction objects 136 from respective associated log partitions 134. The constraint objects 146 may indicate the determined certification constraints 144.

According to an example embodiment, each selected one of the certification algorithm executions 112 may be configured to process each pair of the transactions 106 assigned to the selected one, that access a same database partition 110, in an ordering in which the transaction objects 136 associated with each pair of transactions 106 are stored in each respective log partition 134 that is associated with the same accessed database partition 110.

According to an example embodiment, each of the transaction objects 136 includes information indicating one or more execution operations associated with each respective associated transaction 106.

According to an example embodiment, the plurality of certification algorithm executions 112 may include a multi-partition certification algorithm execution 112a configured to certify transactions 106 that access shared data 108 that is stored in a plurality of the database partitions 110, and a set of single-partition certification algorithm executions 112b-112n. Each single-partition certification algorithm execution 112b-112n may be configured to certify transactions 106 that access shared data 108 that is stored in a single associated one of the database partitions 110.

According to an example embodiment, the scheduler 140 may be configured to assign each of the transactions 106 to the selected one of the certification algorithm executions 112, based on determining shared data access attributes 148 associated with the respective transactions 106.

According to an example embodiment, the plurality of certification algorithm executions 112 may include one or more of a first group of the certification algorithm executions implemented via a plurality of threads within a single process, a second group of the certification algorithm executions implemented via a plurality of processes co-located at a same computing device, or a third group of the certification algorithm executions distributed across a plurality of different computing devices.

According to an example embodiment, the plurality of certification algorithm executions 112 may determine a respective commit status 150 associated with each of the respective transactions 106, wherein the plurality of certification algorithm executions 112 are each based on an optimistic concurrency control (OCC) algorithm. For example, the commit status 150 may include a status of commit or abort, indicating whether the respective transaction 106 commits or aborts.

According to an example embodiment, the scheduler 140 may be configured to store last assigned log sequence numbers associated with single-partition certification algorithm executions in a first map, and last assigned log sequence numbers associated with a multi-partition certification algorithm execution in a second map.

According to an example embodiment, the plurality of certification algorithm executions 112 may include a plurality of Meld certification algorithm executions.

According to an example embodiment, the plurality of log partitions 134 may include a plurality of Hyder logs.

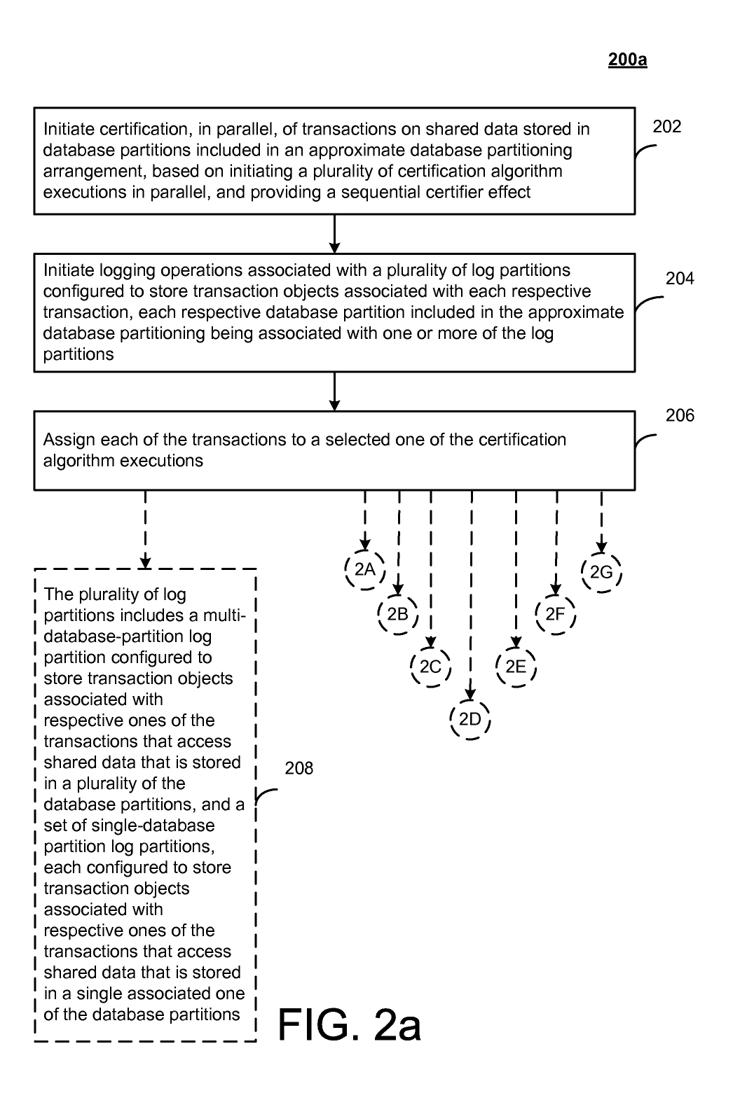

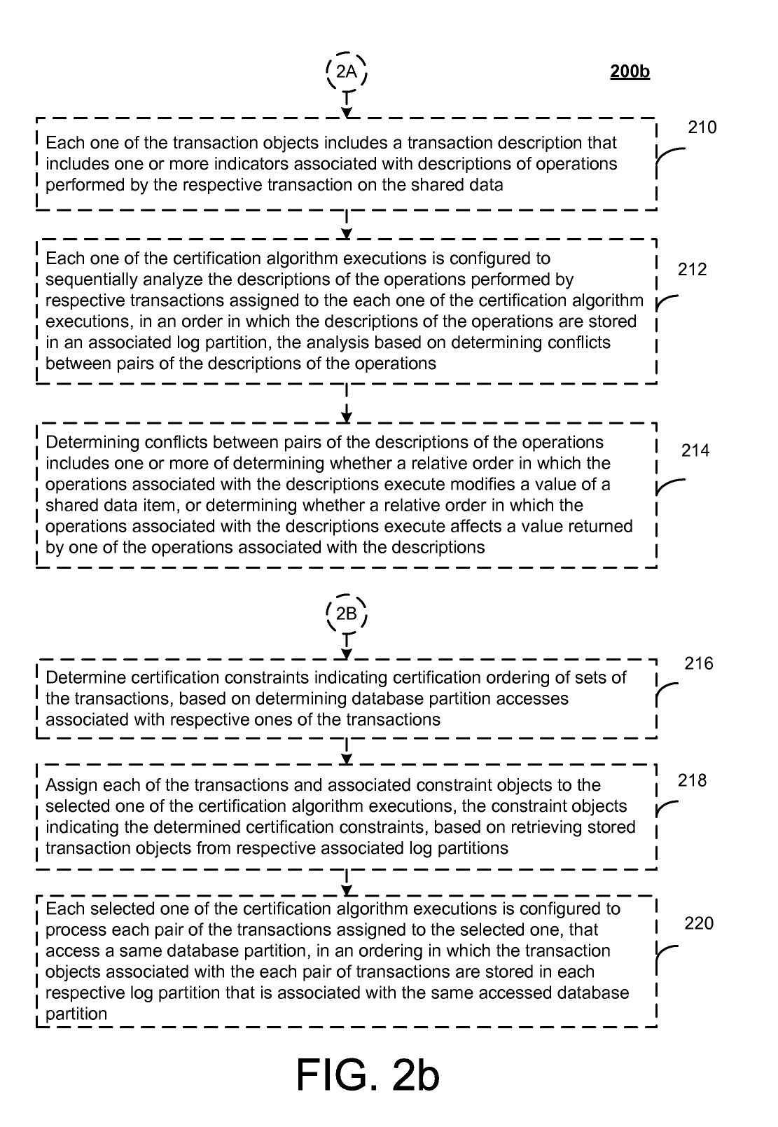

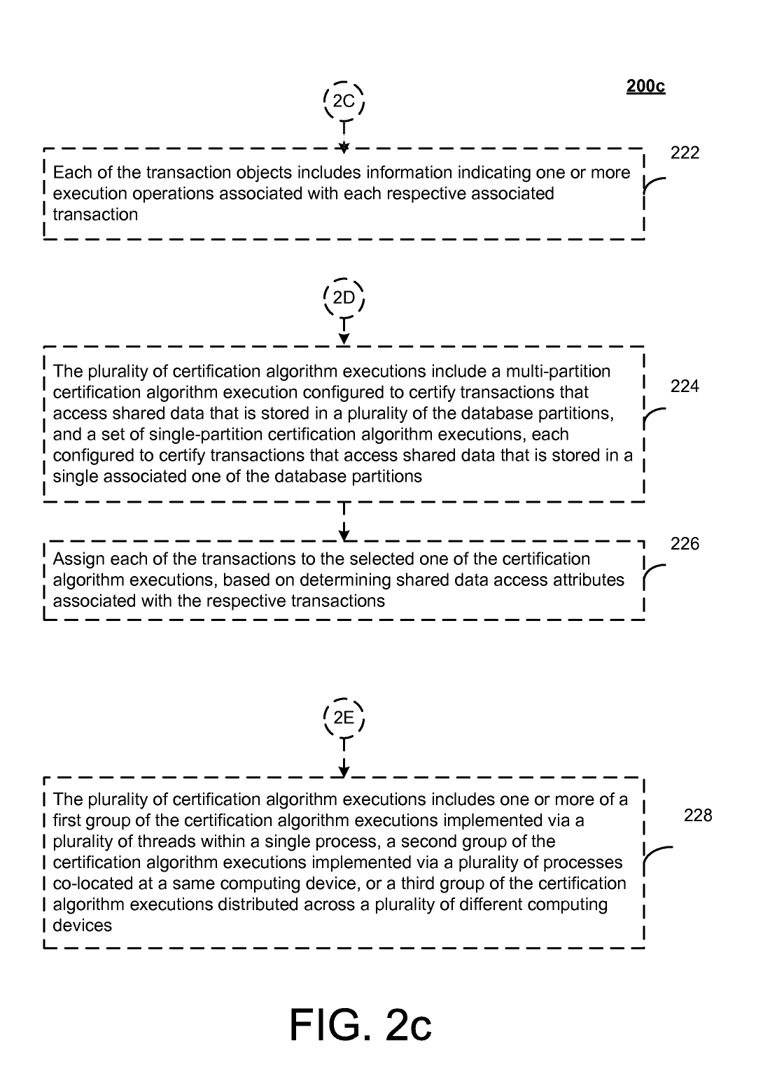

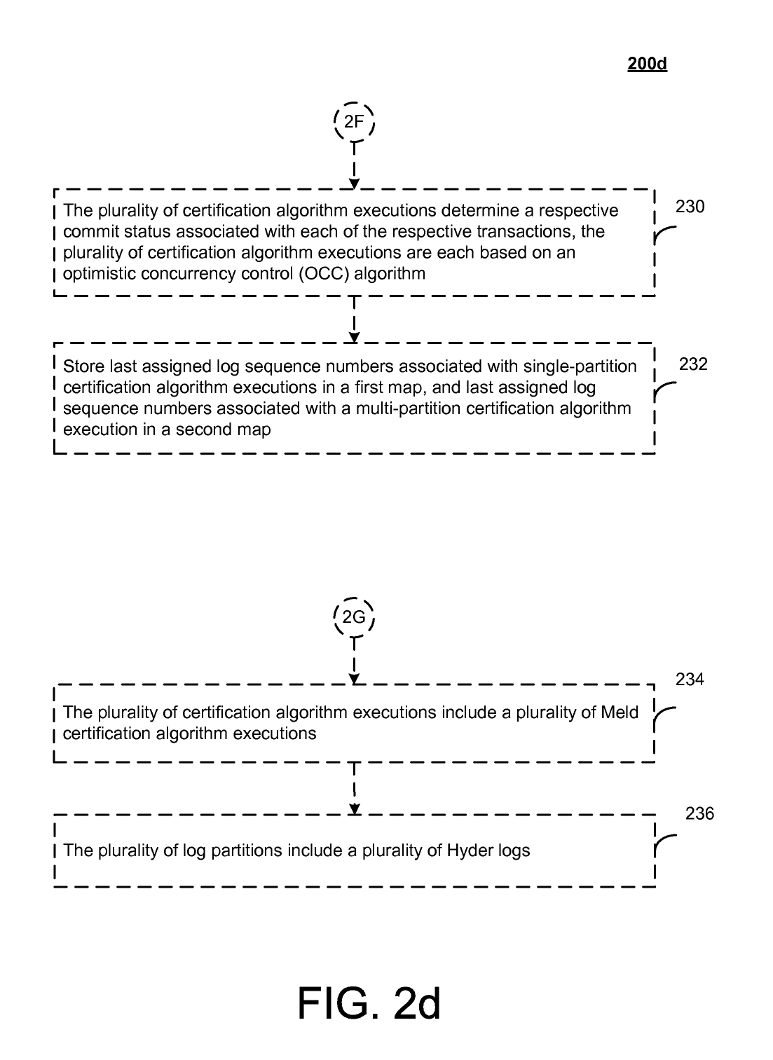

FIG. 2 is a flowchart illustrating example operations of the system of FIG. 1, according to example embodiments. In the example of FIG. 2a, certification, in parallel, of transactions on shared data stored in database partitions included in an approximate database partitioning arrangement may be initiated, based on initiating a plurality of certification algorithm executions in parallel, and may provide a sequential certifier effect (202). For example, the certification component 104 may initiate certification, in parallel, of transactions 106 on shared data 108 stored in database partitions 110 included in an approximate database partitioning arrangement. The certification may be based on initiating a plurality of certification algorithm executions 112 in parallel, and may provide a sequential certifier effect, as discussed above.

Logging operations associated with a plurality of log partitions configured to store transaction objects associated with each respective transaction may be initiated, each respective database partition included in the approximate database partitioning being associated with one or more of the log partitions (204). For example, the log management component 132 may initiate logging operations associated with a plurality of log partitions 134 configured to store transaction objects 136 associated with each respective transaction 106, each respective database partition 110 included in the approximate database partitioning being associated with one or more of the log partitions 134, as discussed above.

Each of the transactions may be assigned to a selected one of the certification algorithm executions (206). For example, the scheduler 140 may assign each of the transactions 106 to a selected one of the certification algorithm executions 112, as discussed above.

According to an example embodiment, the plurality of log partitions may include a multi-database-partition log partition configured to store transaction objects associated with respective ones of the transactions that access shared data that is stored in a plurality of the database partitions, and a set of single-database partition log partitions. Each single-database partition log partition may be configured to store transaction objects associated with respective ones of the transactions that access shared data that is stored in a single associated one of the database partitions (208). For example, the plurality of log partitions 134 may include a multi-database-partition log partition 134a configured to store transaction objects 136a associated with respective ones of the transactions 106 that access shared data 108 that is stored in a plurality of the database partitions 110, and a set of single-database partition log partitions 134b-134n, each configured to store transaction objects 136b-136n associated with respective ones of the transactions 106 that access shared data 108 that is stored in a single associated one of the database partitions 110, as discussed above.

According to an example embodiment, each one of the transaction objects may include a transaction description that includes one or more indicators associated with descriptions of operations performed by the respective transaction on the shared data (210), as indicated in the example of FIG. 2b.

According to an example embodiment, each one of the certification algorithm executions may be configured to sequentially analyze the descriptions of the operations performed by respective transactions assigned to the certification algorithm executions, in an order in which the descriptions of the operations are stored in an associated log partition. The analysis may be based on determining conflicts between pairs of the descriptions of the operations (212). For example, the certification algorithm executions 112 may be configured to sequentially analyze the descriptions of the operations performed by respective transactions 106 assigned to the certification algorithm executions 112, in an order in which the descriptions of the operations are stored in an associated log partition 134. The analysis may be based on determining conflicts between pairs of the descriptions of the operations, as discussed above.

According to an example embodiment, determining conflicts between pairs of the descriptions of the operations may include one or more of determining whether a relative order in which the operations associated with the descriptions execute modifies a value of a shared data item, or determining whether a relative order in which the operations associated with the descriptions execute affects a value returned by one of the operations associated with the descriptions (214).

According to an example embodiment, certification constraints indicating certification ordering of sets of the transactions may be determined, based on determining database partition accesses associated with respective ones of the transactions (216). For example, the certification constraint determination component 142 may determine certification constraints 144 indicating certification ordering of sets of the transactions 106, based on determining database partition accesses associated with respective ones of the transactions 106, as discussed above.

According to an example embodiment, each of the transactions and associated constraint objects may be assigned to the selected one of the certification algorithm executions, the constraint objects indicating the determined certification constraints, based on retrieving stored transaction objects from respective associated log partitions (218). For example, the scheduler 140 may assign each of the transactions 106 and associated constraint objects 146 to the selected one of the certification algorithm executions 112, the constraint objects 146 indicating the determined certification constraints 144, based on retrieving stored transaction objects 136 from respective associated log partitions 134, as discussed above.

According to an example embodiment, each selected one of the certification algorithm executions may be configured to process each pair of the transactions assigned to the selected one, that access a same database partition, in an ordering in which the transaction objects associated with each pair of transactions are stored in each respective log partition that is associated with the same accessed database partition (220). For example, each selected one of the certification algorithm executions 112 may be configured to process each pair of the transactions 106 assigned to the selected one, that access a same database partition 110, in an ordering in which the transaction objects 136 associated with each pair of transactions 106 are stored in each respective log partition 134 that is associated with the same accessed database partition 110, as discussed above.

According to an example embodiment, each of the transaction objects may include information indicating one or more execution operations associated with each respective associated transaction (222), as indicated in the example of FIG. 2c.

According to an example embodiment, the plurality of certification algorithm executions may include a multi-partition certification algorithm execution configured to certify transactions that access shared data that is stored in a plurality of the database partitions, and a set of single-partition certification algorithm executions. Each single-partition certification algorithm execution may be configured to certify transactions that access shared data that is stored in a single associated one of the database partitions (224). For example, the plurality of certification algorithm executions 112 may include a multi-partition certification algorithm execution 112a configured to certify transactions 106 that access shared data 108 that is stored in a plurality of the database partitions 110, and a set of single-partition certification algorithm executions 112b-112n. Each single-partition certification algorithm execution 112b-112n may be configured to certify transactions 106 that access shared data 108 that is stored in a single associated one of the database partitions 110, as discussed above.

According to an example embodiment, each of the transactions may be assigned to the selected one of the certification algorithm executions, based on determining shared data access attributes associated with the respective transactions (226). For example, the scheduler 140 may assign each of the transactions 106 to the selected one of the certification algorithm executions 112, based on determining shared data access attributes 148 associated with the respective transactions 106, as discussed above.

According to an example embodiment, the plurality of certification algorithm executions may include one or more of a first group of the certification algorithm executions implemented via a plurality of threads within a single process, a second group of the certification algorithm executions implemented via a plurality of processes co-located at a same computing device, or a third group of the certification algorithm executions distributed across a plurality of different computing devices (228).

According to an example embodiment, the plurality of certification algorithm executions may determine a respective commit status associated with each of the respective transactions (230), as indicated in the example of FIG. 2d. For example, the plurality of certification algorithm executions 112 may determine a respective commit status 150 associated with each of the respective transactions 106, as discussed above.

According to an example embodiment, last assigned log sequence numbers associated with single-partition certification algorithm executions may be stored in a first map, and last assigned log sequence numbers associated with a multi-partition certification algorithm execution may be stored in a second map (232). For example, the scheduler 140 may be configured to store last assigned log sequence numbers associated with single-partition certification algorithm executions in a first map, and last assigned log sequence numbers associated with a multi-partition certification algorithm execution in a second map, as discussed further herein.

According to an example embodiment, the plurality of certification algorithm executions may include a plurality of Meld certification algorithm executions (234), as discussed further herein.

According to an example embodiment, the plurality of log partitions may include a plurality of Hyder logs (236), as discussed further herein.

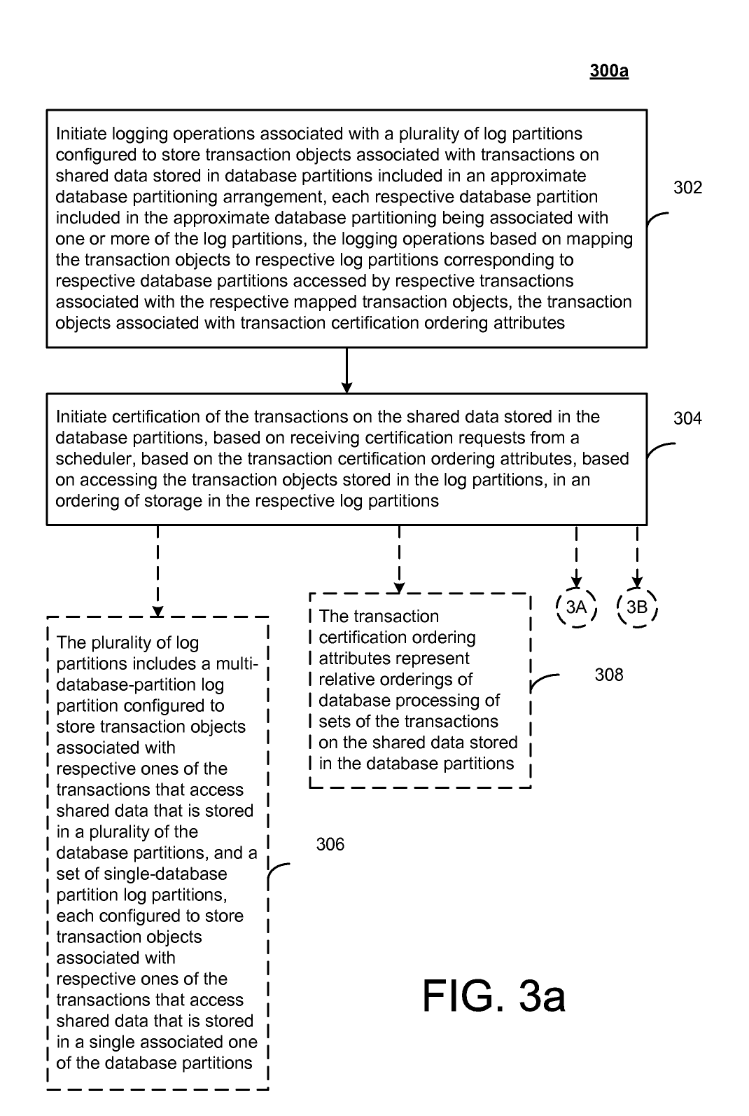

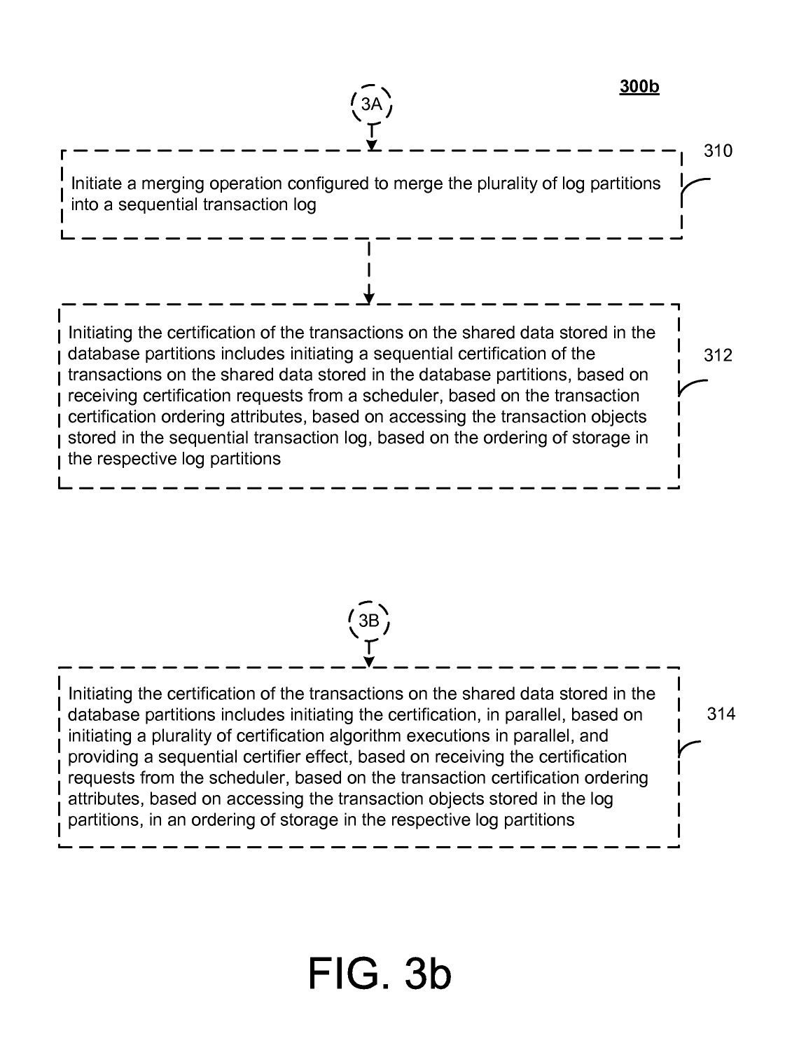

FIG. 3 is a flowchart illustrating example operations of the system of FIG. 1, according to example embodiments. In the example of FIG. 3a, logging operations associated with a plurality of log partitions configured to store transaction objects associated with transactions on shared data stored in database partitions included in an approximate database partitioning arrangement may be initiated. Each respective database partition included in the approximate database partitioning may be associated with one or more of the log partitions. The logging operations may be based on mapping the transaction objects to respective log partitions corresponding to respective database partitions accessed by respective transactions associated with the respective mapped transaction objects. The transaction objects may be associated with transaction certification ordering attributes (302). For example, the log management component 132 may initiate logging operations associated with a plurality of log partitions 134 configured to store transaction objects 136, as discussed above.

Certification of the transactions on the shared data stored in the database partitions may be initiated, based on receiving certification requests from a scheduler, based on the transaction certification ordering attributes, based on accessing the transaction objects stored in the log partitions, in an ordering of storage in the respective log partitions (304). For example, the certification component 104 may initiate certification of the transactions 106.

According to an example embodiment, the plurality of log partitions may include a multi-database-partition log partition configured to store transaction objects associated with respective ones of the transactions that access shared data that is stored in a plurality of the database partitions, and a set of single-database partition log partitions. Each single-database partition may be configured to store transaction objects associated with respective ones of the transactions that access shared data that is stored in a single associated one of the database partitions (306). For example, the plurality of log partitions 134 may include a multi-database-partition log partition 134a configured to store transaction objects 136a associated with respective ones of the transactions 106 that access shared data 108 that is stored in a plurality of the database partitions 110, and a set of single-database partition log partitions 134b-134n. Each single-database partition log partitions 134b-134n may be configured to store transaction objects 136b-136n associated with respective ones of the transactions 106 that access shared data 108 that is stored in a single associated one of the database partitions 110, as discussed above.

According to an example embodiment, the transaction certification ordering attributes may represent relative orderings of database processing of sets of the transactions on the shared data stored in the database partitions (308).

According to an example embodiment, a merging operation configured to merge the plurality of log partitions into a sequential transaction log may be initiated (310), as indicated in the example of FIG. 3b.

According to an example embodiment, initiating the certification of the transactions on the shared data stored in the database partitions may include initiating a sequential certification of the transactions on the shared data stored in the database partitions. Initiating the certification may be based on receiving certification requests from a scheduler, based on the transaction certification ordering attributes, based on accessing the transaction objects stored in the sequential transaction log, based on the ordering of storage in the respective log partitions (312), as discussed further herein.

According to an example embodiment, initiating the certification of the transactions on the shared data stored in the database partitions may include initiating the certification, in parallel, based on initiating a plurality of certification algorithm executions in parallel, and providing a sequential certifier effect. Initiating the certification may be based on receiving the certification requests from the scheduler, based on the transaction certification ordering attributes, based on accessing the transaction objects stored in the log partitions, in an ordering of storage in the respective log partitions (314).

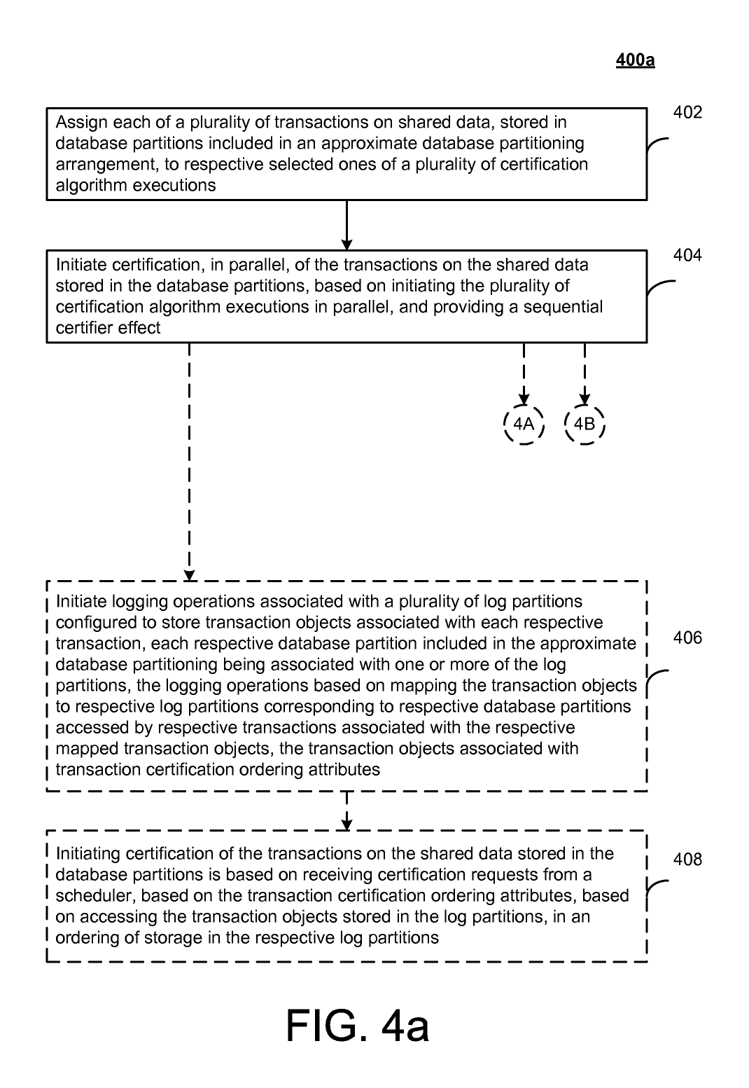

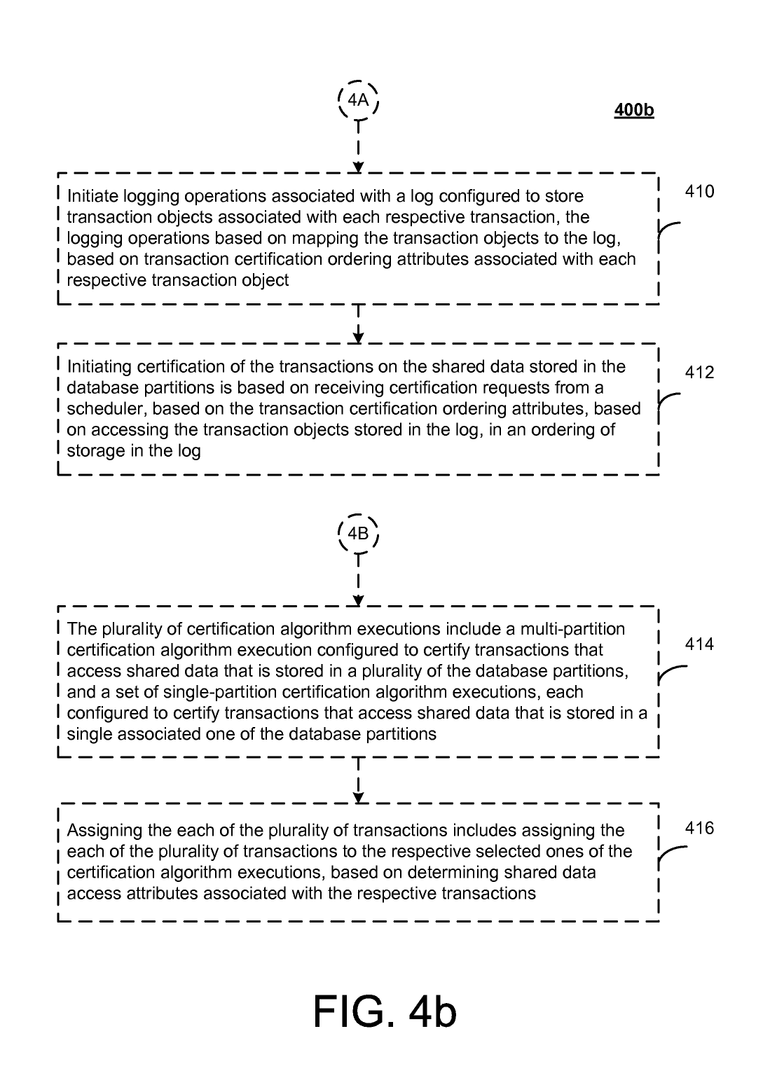

FIG. 4 is a flowchart illustrating example operations of the system of FIG. 1, according to example embodiments. In the example of FIG. 4a, each of a plurality of transactions on shared data, stored in database partitions included in an approximate database partitioning arrangement, may be assigned to respective selected ones of a plurality of certification algorithm executions (402). For example, the scheduler 140 may assign each of the transactions 106 to the selected one of the certification algorithm executions 112, as discussed above.

Certification, in parallel, of the transactions on the shared data stored in the database partitions, may be initiated, based on initiating the plurality of certification algorithm executions in parallel, and providing a sequential certifier effect (404). For example, the certification component 104 may initiate certification, in parallel, of transactions 106 on shared data 108 stored in database partitions 110 included in an approximate database partitioning arrangement, based on initiating a plurality of certification algorithm executions 112 in parallel, and providing a sequential certifier effect, as discussed above.

According to an example embodiment, logging operations associated with a plurality of log partitions configured to store transaction objects associated with each respective transaction may be initiated, each respective database partition included in the approximate database partitioning being associated with one or more of the log partitions. The logging operations may be based on mapping the transaction objects to respective log partitions corresponding to respective database partitions accessed by respective transactions associated with the respective mapped transaction objects. The transaction objects may be associated with transaction certification ordering attributes (406). For example, the log management component 132 may initiate logging operations associated with a plurality of log partitions 134 configured to store transaction objects 136 associated with each respective transaction 106, each respective database partition 110 included in the approximate database partitioning being associated with one or more of the log partitions 134, as discussed above.

According to an example embodiment, initiating certification of the transactions on the shared data stored in the database partitions may be based on receiving certification requests from a scheduler, based on the transaction certification ordering attributes, based on accessing the transaction objects stored in the log partitions, in an ordering of storage in the respective log partitions (408), as discussed further herein.

According to an example embodiment as shown in FIG. 4b, the logging operations associated with a log configured to store transaction objects associated with each respective transaction may be initiated, the logging operations based on mapping the transaction objects to the log, based on transaction certification ordering attributes associated with each respective transaction object (410), as discussed further herein.

According to an example embodiment, initiating certification of the transactions on the shared data stored in the database partitions may be based on receiving certification requests from a scheduler, based on the transaction certification ordering attributes, based on accessing the transaction objects stored in the log, in an ordering of storage in the log (412), as discussed further herein.

According to an example embodiment, the plurality of certification algorithm executions may include a multi-partition certification algorithm execution configured to certify transactions that access shared data that is stored in a plurality of the database partitions, and a set of single-partition certification algorithm executions. Each single-partition certification algorithm execution may be configured to certify transactions that access shared data that is stored in a single associated one of the database partitions (414). For example, the plurality of certification algorithm executions 112 may include a multi-partition certification algorithm execution 112a configured to certify transactions 106 that access shared data 108 that is stored in a plurality of the database partitions 110, and a set of single-partition certification algorithm executions 112b-112n, each configured to certify transactions 106 that access shared data 108 that is stored in a single associated one of the database partitions 110, as discussed above.

According to an example embodiment, assigning each of the plurality of transactions may include assigning each of the plurality of transactions to the respective selected ones of the certification algorithm executions, based on determining shared data access attributes associated with the respective transactions (416). For example, the scheduler 140 may assign each of the transactions 106 to the selected one of the certification algorithm executions 112, based on determining shared data access attributes 148 associated with the respective transactions 106, as discussed above.

As discussed further below, example techniques discussed herein may use an “approximate” database partitioning, a certification algorithm (C), and an algorithm to atomically append entries to a log as input. In accordance with example embodiments discussed herein, a system may include three components, which may be described as a logical database partition P₀, a parallelized certifier, and a partitioned log, as discussed further below.

In accordance with example embodiments discussed herein, given an approximate database partitioning P={P₁, P₂, . . . , Pₙ}, an additional logical partition P₀ may be provided. Each transaction that accesses only one partition may be assigned to the partition that it accesses. Each transaction that accesses two or more partitions may be assigned to partition P₀.

In accordance with example embodiments discussed herein, the certifier may be parallelized into n+1 parallel executions C={C₀, C₁, C₂, . . . , Cₙ}, one for each partition, including the logical partition. Each single-partition transaction (e.g., accesses a single partition) may be processed by the certifier execution assigned to its partition. Each multi-partition transaction (e.g., accesses two or more partitions) may be processed by the logical partition's execution of the certifier. In accordance with example embodiments discussed herein, synchronization constraints may be generated, between the logical partition's certifier and the partition-specific certifiers so they may reach consistent decisions.

In accordance with example embodiments discussed herein, the log may be partitioned into n+1 distinct logs L={L₀, L₁, L₂, . . . , Lₙ}, one associated with each partition and one associated with the logical partition. As discussed further below, the logs may be synchronized so that the set of all intentions across all logs is partially ordered, such that every pair of conflicting transactions appears in the same relative order in all logs in which they both appear. For example, the ordering may include a low-overhead sequencing scheme based on vector clocks.

Example techniques discussed herein may be used with any approximate database partitioning. Since multi-partition transactions may be more expensive than single-partition transactions, many users may prefer techniques for which fewer multi-partition transactions are induced by the database partitioning.

In accordance with example embodiments discussed herein, the synchronization performed between parallel executions of the OCC algorithm may be external to the OCC algorithm. Therefore, example techniques discussed herein may also be used with any OCC algorithm. The same is true for the synchronization performed between parallel logs.

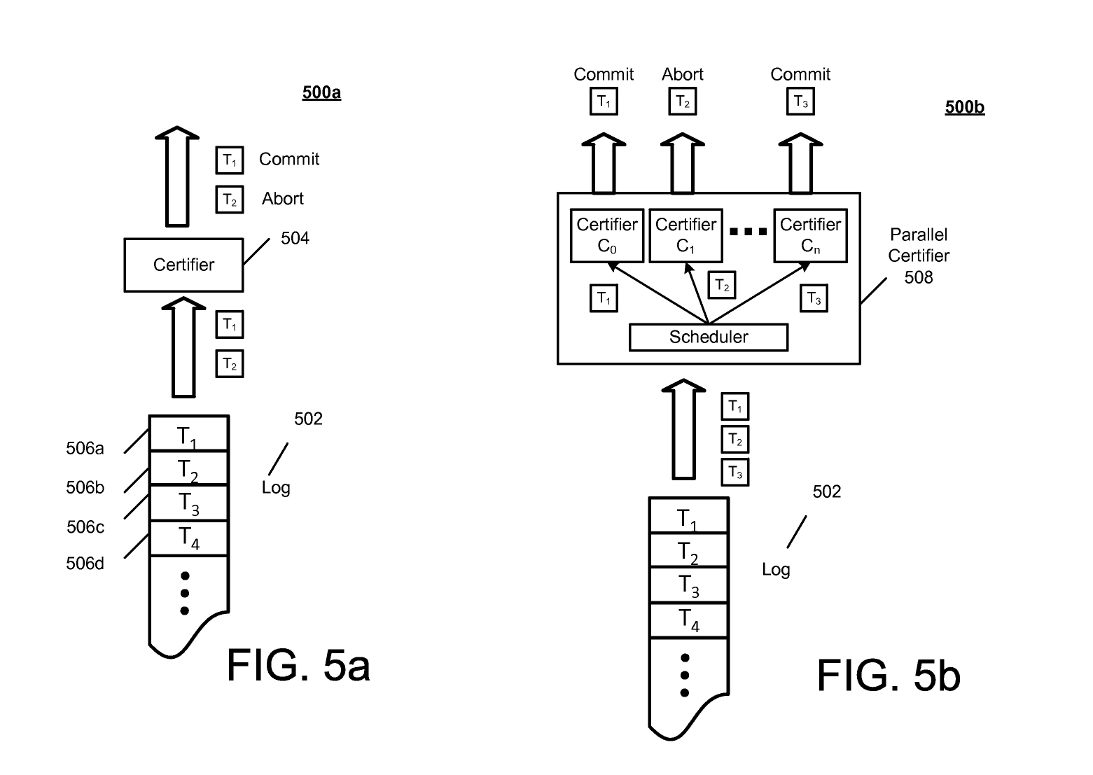

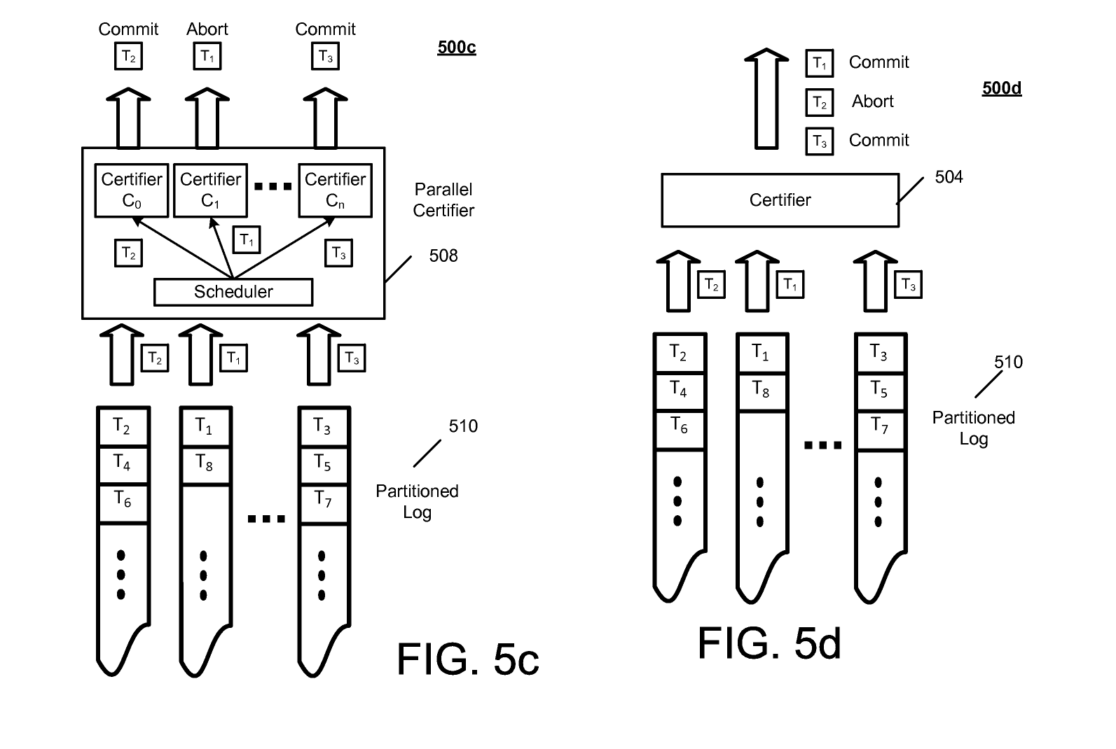

FIG. 5 depicts example structures of transaction processing systems with an approximate database partitioning and using various combinations of a single log, a partitioned log, a sequential certifier, and a parallelized certifier. For example, FIG. 5a depicts an example transaction processing system 500a using a single log 502 processed by a sequential certifier 504. As shown in FIG. 5a, transactions 506a-506d may be appended to the single log 502, thus providing a total order to the set of all transactions. The certifier 504 may process transactions in log order to determine whether a transaction commits or aborts.

FIG. 5b depicts an example transaction processing system 500b using an approximate database partitioning and a single log 502 and parallel certifier 508.

FIG. 5c depicts an example transaction processing system 500c using an approximate database partitioning and a partitioned log 510 and parallel certifier 508.

FIG. 5d depicts an example transaction processing system 500d using an approximate database partitioning and a partitioned log 510 and a sequential certifier 504.

In accordance with example embodiments discussed herein, the certifier's analysis may rely on the concept of conflicting operations. For example, two operations may conflict if the relative order in which they execute affects the value of a shared data item or the value returned by one of the operations. Examples of conflicting operations include read and write, where a write operation on a data item conflicts with a read or write operation on the same data item. For example, two transactions may conflict if one transaction includes an operation that conflicts with at least one operation of the other transaction.

As another example, determining conflicts may include one or more of determining that a first transaction writes to a first shared data item that is read by a second transaction, determining that a second transaction is a read-only transaction, or determining that two or more transactions write to a same shared data item.

To determine whether a transaction T commits or aborts, a certifier may analyze whether any of T's operations conflict with operations issued by other concurrent transactions that it previously analyzed. For example, if two transactions executed concurrently and include conflicting accesses to the same data, such as independent writes of a data item x or concurrent reads and writes of x, then the algorithm might conclude that one of the transactions will be aborted. Different certifiers may use different rules to reach their decision. However, certifiers may typically rely in part on the relative order of conflicting transactions in making their determinations.

The certifier algorithm and the log that contains the sequence of intentions may have throughput limits imposed by the underlying hardware. For example, such limits are discussed in Philip A. Bernstein, et al., Concurrency Control and Recovery in Database Systems, Addison-Wesley, 1987. For example, this may limit the scalability of a system that uses them.

As discussed further herein, for example, throughput may be improved by parallelizing the algorithm and/or partitioning the log. For example, if the certifier can be parallelized, then independent processors may execute the algorithm on a subset of the transactions in the sequence. For example, if the log can be partitioned, then it may be distributed over independent storage devices to provide higher aggregate throughput of read and append operations to the log.

As discussed above, a database partitioning may be represented as a set of partition names, such as {P₁, P₂, . . . }, and an assignment of each data item in the database to one of the partitions. A database partitioning may be referred to as a “perfect” database partitioning with respect to a set of transactions T={T₁, T₂, . . . } if every transaction in T reads and writes data in at most one partition, e.g., the database partitioning induces a transaction partitioning. If a database is perfectly partitioned, then the certifier may be parallelized and the log may be partitioned in a straightforward manner. For example, for each database partition Pᵢ, a separate log Lᵢ and an independent execution Cᵢ of the certifier algorithm may be generated. For this example, all transactions that access Pᵢ may append their intentions to Lᵢ, and Cᵢ may take Lᵢ as its input. For example, since transactions in different logs do not conflict, there is not likely a significant concern over shared data or synchronization between the logs or between executions of the certifier on different partitions. However, a perfect partitioning is not possible in many practical situations, so this simple parallelization technique may not be feasible in many contexts.

Thus, for example, a database partitioning may be referred to herein as “approximate” with respect to a set of transactions T, if most transactions in T read and write data in at most one partition, e.g., some transactions in T access data in two or more partitions (so the partitioning is not perfect), but most do not.

In an approximate partitioning, the transactions that access only one partition may be processed via the same (or similar) techniques as with a perfect partitioning. However, transactions that access two or more partitions may add complexity to partitioning the certifier, as such multi-partition transactions may conflict with transactions that are being analyzed by different executions of the certifier algorithm, which creates dependencies between such executions. For example, if data items x and y are assigned to different partitions P₁ and P₂, and if transaction Tᵢ writes x and y, then Tᵢ may be evaluated by C₁ to determine whether it conflicts with concurrent transactions that accessed x and by C₂ to determine whether it conflicts with concurrent transactions that accessed y. However, these evaluations are not independent. For example, if C₁ determines that Tᵢ will be aborted, then that information is needed by C₂, since C₂ no longer has the option to commit Tᵢ. When multiple transactions access different combinations of partitions, such scenarios may become significantly complex.

As another example, a transaction that accesses two or more partitions may also add complexity to partitioning the log, as it may be advantageous that the transaction's intentions be ordered in the logs relative to all conflicting transactions. Continuing with the example of transaction Tᵢ above, decisions may be made with regard to whether its intention will be logged on L₁, L₂, or some other log. Wherever it is logged, for example, it may be desirable that it be ordered relative to all other transactions that have conflicting accesses to x and y before it is provided to the OCC algorithm.

In accordance with example embodiments discussed herein, the certifier may be parallelized and/or the log may be partitioned relative to an approximate database partitioning. For example, techniques discussed herein may utilize an approximate database partitioning, an OCC algorithm, and an algorithm to atomically append entries to the log as input.

More generally, the synchronization performed between parallel executions of the certifier algorithm may be external to the certifier algorithm, and thus, example techniques discussed herein may be used with any certifier algorithm. The same is true for the synchronization performed between parallel logs.

In accordance with example embodiments discussed herein, the designs of the parallel certifier algorithm and partitioned log may be independent. Thus, an example system may utilize a parallel certifier algorithm with or without parallelizing the log and vice versa.

According to an example embodiment, a parallel certifier may utilize a single totally-ordered log. In this context, the term “certifier” may also refer to a certifier execution. A certifier's execution may be parallelized using multiple threads within a single process, multiple processes co-located at a same machine or computing device, or distributed across multiple different machines.

According to an example embodiment, a parallel certifier may utilize one certifier Cᵢ dedicated to process intentions from single-partition (single-database-partition) transactions on partition Pᵢ, and one certifier C₀ dedicated to process intentions from multi-partition (multi-database-partition) transactions. A single scheduler S may process intentions in log-order, assigning each intention to one of the certifiers. The certifiers may process non-conflicting intentions in parallel. However, conflicting intentions are processed in log order.

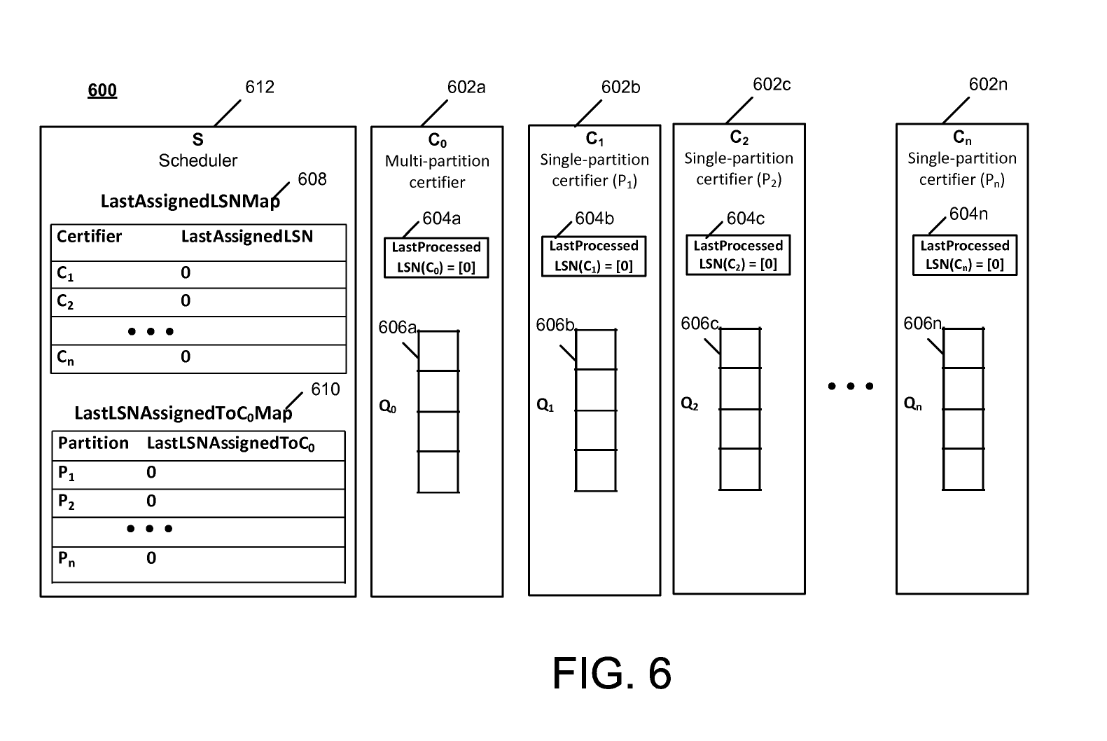

According to an example embodiment, S passes synchronization constraints to each Cᵢ to ensure that intentions of conflicting transactions are certified in the order in which they appear in the log. FIG. 6 depicts a parallel certifier 602a-602n indicating example variables 604a-604n and data structures 606a-606n maintained by each certifier Cᵢ (602a-602n), and the data structures 608, 610 used by S 612 to determine synchronization constraints 144 passed to each Cᵢ (602a-602n). For example, the parallel certifier 602a-602n may correspond to the certifier executions 112 of FIG. 1 discussed above. As indicated in FIG. 6, each certifier Cᵢ (602a-602n) may perform atomic blind writes to its variable LastProcessedLSN(Cᵢ) (604a-604n) while other certifiers may atomically read these variables. As shown in the example of FIG. 6, LastAssignedLSNMap 608 and LastLSNAssignedToC₀Map 610 are structures local to the scheduler, S 612. S 612 may use these maps to determine synchronization constraints 144 for the certifiers. For example, S 612 may correspond to the scheduler 140 of FIG. 1, as discussed above. According to an example embodiment, each certifier Cᵢ (604a-604n) may be associated with a respective producer-consumer queue 606a-606n, wherein S 612 is the producer and Cᵢ (604a-604n) is the consumer associated with the queue (606a-606n).

According to an example embodiment, each intention in the log (e.g., log 134) is associated with a location, which may be referred to herein as its “log sequence number,” or LSN, which indicates a relative order of intentions in the log. For example, intention Intᵢ precedes intention Intₖ in the log if and only if the LSN of Intᵢ is less than the LSN of Intₖ.

According to an example embodiment, each certifier Cᵢ (∀iε[0, n]) (602a-602n) may maintain a variable LastProcessedLSN(Cᵢ) (604a-604n) that stores the LSN of the last transaction processed by Cᵢ (602a-602n). For example, when Cᵢ (602a-602n) completes certifying a transaction Tₖ, it sets LastProcessedLSN(Cᵢ) (604a-604n) equal to Tₖ's LSN. Cᵢ may perform this update of LastProcessedLSN(Cᵢ) irrespective of whether Tₖ committed or aborted. Cⱼ (∀j≠i) may atomically read LastProcessedLSN(Cᵢ) but may not be allowed to update the value. According to an example embodiment, each LastProcessedLSN(Cᵢ), iε[1, n] (604b-602n) may be read only by C₀ 602a and LastProcessedLSN(C₀) 604a may be read by all Cᵢ ∀iε[1, n] (602b-602n).

According to an example embodiment, each Cᵢ (602a-602n) may also be associated with a producer-consumer queue (606a-606n) wherein S 612 enqueues the transactions 106 that Cᵢ (602a-602n) is expected to process (e.g., S 612 is the producer) and Cᵢ (602a-602n) dequeues the transaction when it completes processing its previous transaction (e.g., Cᵢ (602a-602n) is a consumer).

According to an example embodiment, the scheduler S 612 may maintain a local structure, LastAssignedLSNMap 608 that maps Cᵢ (∀iε[1, n]) (602a-602n) to the LSN of the last single-partition transaction 106 it assigned to Cᵢ. S 612 may maintain another local structure, LastLSNAssignedToC₀Map 610, that stores a map of a partition Pᵢ (110a-110n) to the LSN of the last multi-partition transaction that it assigned to C₀ 602a and that accessed Pᵢ (110a-110n).

According to an example embodiment, each certifier Cᵢ (602a-602n) may behave as if it were processing all single-partition and multi-partition transactions 106 that access Pᵢ (110a-110n) in log order, based on synchronization between certifiers (602a-602n). For example, a transaction T 106 that accesses partition Pᵢ (110a-110n) may satisfy a parallel certification constraint 144, indicated more formally as:
Before T is certified, all transactions that precede T in the log and that accessed Pᵢ will have been certified.

For example, this condition may be satisfied by a sequential certification of transactions 106. Threads in a parallel certifier 602 may synchronize to ensure that the condition holds. For each transaction T 106, S 612 may determine which certifier Cᵢ will process T 106. For example, S 612 may use its two local data structures, LastAssignedLSNMap 608 and LastLSNAssignedToC₀Map 610, to determine and provide Cᵢ (602a-602n) with the synchronization constraints 144 to be satisfied before Cᵢ (602a-602n) can process T 106.

According to an example embodiment, meld threads may be synchronized, as discussed further below.

If Tᵢ denotes a transaction 106 that S 612 is currently processing, S 612 may generate the synchronization constraint 144 for Tᵢ as discussed further below. According to an example embodiment, once S 612 determines the constraints 144, it may enqueue the transaction 106 and the constraints 144 to the queue 606a-606n corresponding to the certifier (602a-602n).

According to an example embodiment, if Tᵢ 106 accessed a single partition Pᵢ 110a-110n, then Tᵢ 106 may be assigned to the single-partition certifier Cᵢ (602b-602n). Cᵢ may synchronize with C₀ 602a before processing Tᵢ 106 to ensure that the parallel certification constraint 144 is satisfied. If Tₖ denotes the last transaction that S 612 assigned to C₀ 602a such that LSN(Tₖ)<LSN(Tᵢ) and Tₖ updated Pᵢ, S 612 may maintain this information in LastLSNAssignedToC₀Map (Pᵢ) 610. S 612 may pass the synchronization constraint LastProcessedLSN(C₀)≧K (144) to Cᵢ along with Tᵢ, where K indicates the current value of LastLSNAssignedToC₀Map (Pᵢ) 610. For example, the constraint 144 may inform Cᵢ (602a-602n) that it can process Tᵢ 106 only after C₀ 602a has finished processing Tₖ. When Cᵢ starts processing Tᵢ's intention, it may access the variable LastProcessedLSN(C₀) 604a. If the constraint 144 is satisfied, Cᵢ can start processing Tᵢ. If the constraint is not satisfied, then Cᵢ may either poll the variable LastProcessedLSN(C₀) 604a until the constraint 144 is satisfied or uses an event mechanism to ask C₀ 602a to notify it when LastProcessedLSN(C₀)≧K.

According to an example embodiment, if Tᵢ 106 accessed multiple partitions {Pᵢ₁, Pᵢ₂, . . . } (110), then S 612 may assign Tᵢ to C₀ (602a). C₀ (602a) may synchronize with the certifiers {Cᵢ₁, Cᵢ₂, . . . } (602b-602n) of all the partitions {Pᵢ₁, Pᵢ₂, . . . } (110) accessed by Tᵢ 106. For example, if Tⱼ denotes the last transaction assigned to Pⱼε{Pᵢ₁, Pᵢ₂, . . . }, such that LSN(Tⱼ)<LSN(Tᵢ), S 612 may maintain this information using the structure LastAssignedLSNMap(Cⱼ) 608. According to an example embodiment, the synchronization constraint 144 that S 612 passes to C₀ 602a may include Λ_{∀j:P}_{ⱼ}_{ε{P}_{ᵢ₁}_{, P}_{ᵢ₂}_{, . . . }} LastProcessedLSN(Cⱼ)≧Kⱼ, where Kⱼ, is the value of LastAssignedLSNMap(Cⱼ) (608). For example, the constraint 144 may inform C₀ (602a) that it can process Tᵢ 106 only after all Cⱼ (602b-602n) in {Cᵢ₁, Cᵢ₂, . . . } have finished processing their corresponding Tⱼ's, which are the last transactions that precede Tᵢ and that accessed a partition that Tᵢ accessed. When C₀ (602a) starts processing Tᵢ's intention, it may read the variables LastProcessedLSN(Cⱼ) ∀j: Pⱼε{Pᵢ₁, Pᵢ₂, . . . }. According to an example embodiment, if the constraint 144 is satisfied, C₀ (602a) may start processing Tᵢ 106. If the constraint 144 is not satisfied, then C₀ (602a) may either poll the variables LastProcessedLSN(Cⱼ) (604b-604n) for all j such that Pⱼε{Pᵢ₁, Pᵢ₂, . . . } until the constraint is satisfied or may use an event mechanism to ask each Cⱼ in {Cᵢ₁, Cᵢ₂, . . . } to notify it when LastProcessedLSN(Cⱼ)≧K_{J}.

In this example, for all j such that Pⱼε{Pᵢ₁, Pᵢ₂, . . . }, the value of the variable LastProcessedLSN(Cⱼ) 604 increases monotonically over time. Thus, once the constraint LastProcessedLSN(Cⱼ)≧Kⱼ becomes true, it will remain true. Therefore, C₀ (602a) can read each variable LastProcessedLSN(Cⱼ) (604) independently, without synchronization. For example, there is no need to read all of the variables LastProcessedLSN(Cⱼ) (604) within a critical section.

As an example, a database may include three partitions P₁, P₂, P₃ (110), such that C₁, C₂, C₃ (602) are parallel certifiers assigned to P₁, P₂, P₃ (110) respectively, and C₀ (602a) is the certifier responsible for multi-partition transactions. For this example, the following sequence of transactions 106 may be associated with the database processing:
T₁^{[P}^{₂}^{]}, T₂^{[P}^{₁}^{]}, T₃^{[P}^{₂}^{]}, T₄^{[P}^{₃}^{]}, T₅^{[P}^{₁}^{, P}^{₂}^{]}, T₆^{[P}^{₂}^{]}, T₇^{[P}^{₃}^{]}, T₈^{[P}^{₁}^{, P}^{₃}^{]}, T₉^{[P}^{₂}^{]}

For this example, a transaction 106 may be represented in the form Tᵢ^{[P}^{ⱼ}^{]} where i is an identifier assigned to a transaction 106 and [Pⱼ] is the set of partitions 110 that that Tᵢ accesses. In this example, the transaction's identifier i may also be used as its LSN. Thus, for this example, T₁ appears in position 1 in the log (e.g., 134), T₂ is in position 2, and so on.

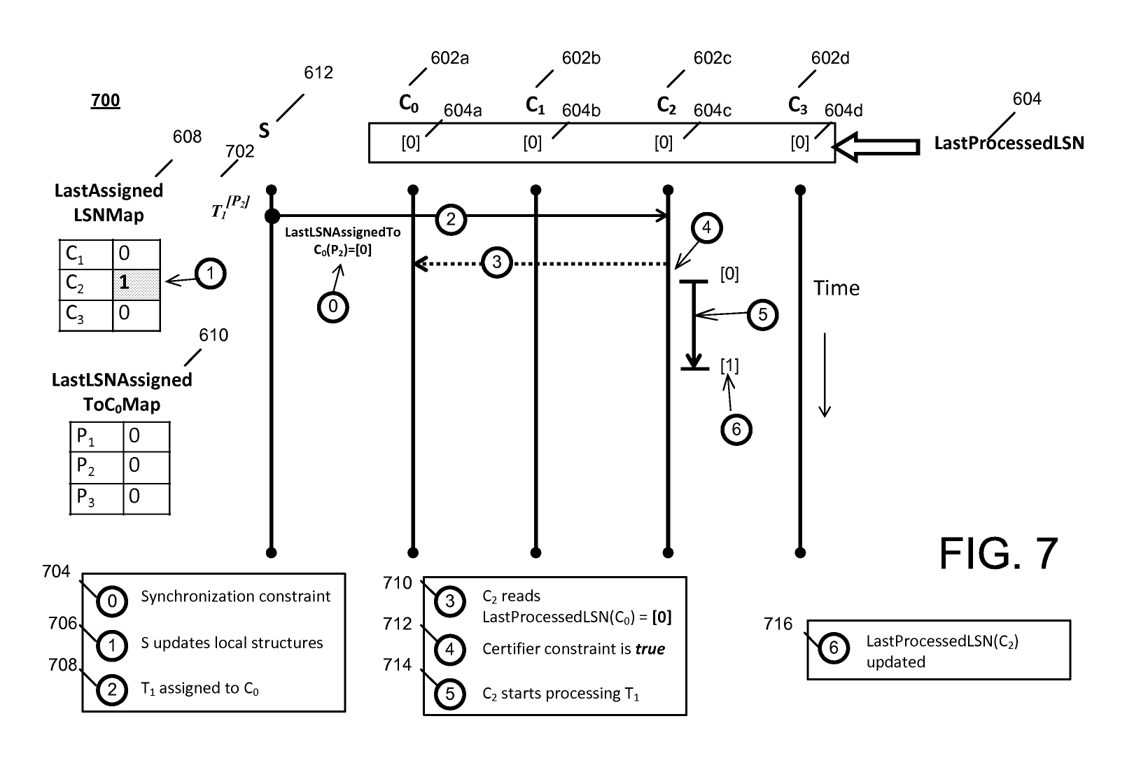

According to an example embodiment, S 612 processes the transactions 106 (e.g., intentions) in log order. For each transaction, S 612 determines the synchronization constraint 144 to be passed to the certifiers 602a-602n to ensure that transactions 106 accessing the same partitions 110 are processed in log order. As discussed below, FIGS. 7-13 illustrate the parallel certifier 602 in action while it is processing the above sequence of transactions, indicating communication and synchronization of the certifiers 602a-602n. As shown in FIGS. 7-13 time progresses from top to bottom. Each of FIGS. 7-13, focuses on a transaction 106 at the tail of the log 134 being processed by S 612.

FIG. 7 depicts an example processing 700 of a single-partition transaction 106 by a parallel certifier 602. As shown in FIG. 7, a single-database-partition transaction in set 702 accessed partition P₂. For single-partition transactions, S 612 reads LastLSNAssignedToC₀Map 610 to generate the constraint 144 and updates LastAssignedLSNMap 608 with the current transaction's LSN.

FIG. 7 illustrates a single-partition transaction T₁ accessing P₂. As shown in FIG. 7, a set of transactions 702 may be processed by the scheduler S 612. The circled numbers referenced by 704-714 identify points in the execution. At 704, S 612 determines the synchronization constraint 144 it will pass to C₂, namely, that C₀ will have at least finished processing the last multi-partition transaction T₀ that accessed P₂. S 612 determines T₀'s LSN by reading LastLSNAssignedToC₀Map(P₂) (610). Since S 612 has not processed any multi-partition transaction before T₁, the constraint 144 is LastProcessedLSN(C₀)≧0. At 706, S 612 updates LastAssignedLSNMap(C₂)=1 to reflect its assignment of T₁ to C₂ (602c). At 708, S 612 assigns transaction T₁ to C₂ (602c), after which it moves to the next transaction 106 in the log (e.g., 134). At 710, C₂ (602c) reads LastProcessedLSN(C₀) (604a) as 0 and hence determines at 712 that the constraint 144 is satisfied. Therefore, at 714, C₂ (602c) starts processing T₁ (in set 702). After C₂ (602b) completes processing T₁ (in set 702), at 716, it updates LastProcessedLSN(C₂) (604c) to 1.

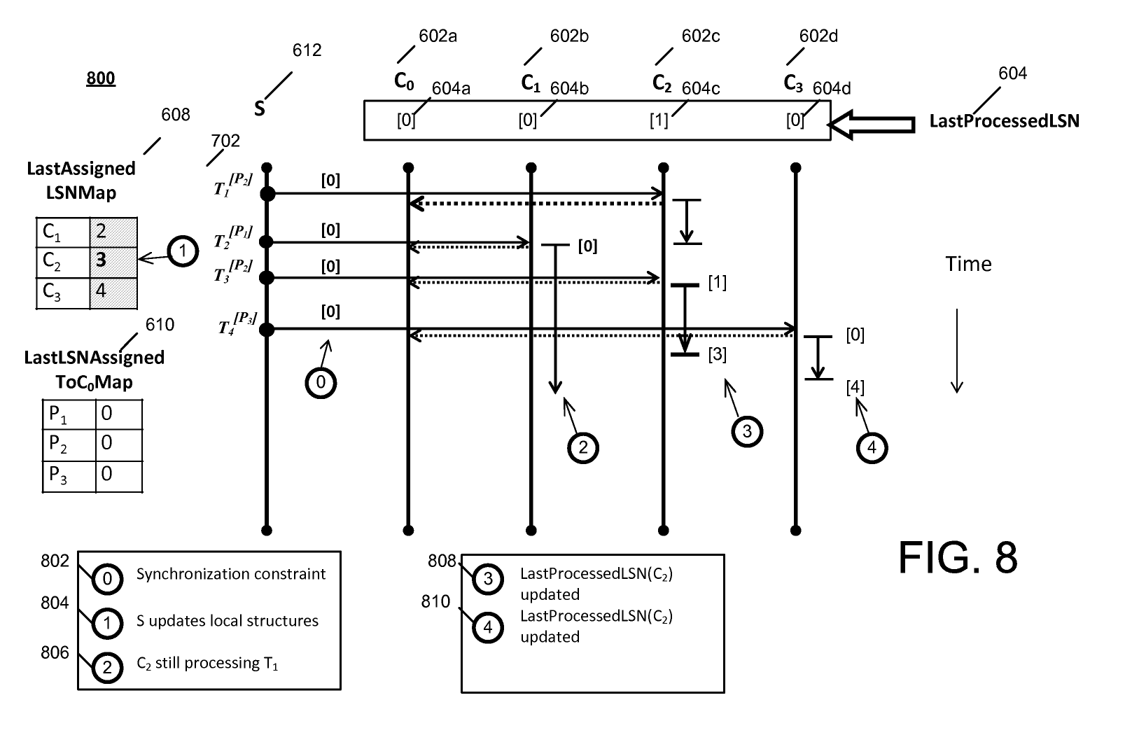

FIG. 8 illustrates an example processing 800 of single-partition transactions. For example, FIG. 8 illustrates the processing of the next three single-partition transactions—T₂, T₃, T₄—using steps similar to those discussed above with regard to FIG. 7, as S 612 processes transactions in the set 702 in log order and updates its local structures. The certifiers 602 process the transactions in set 702 which S 612 assigns them. Before a transaction is processed, Cᵢ checks to ensure that the synchronization constraint 144 is satisfied. Once a transaction is processed, Cᵢ updates its own variable LastProcessedLSN(Cᵢ) (604).

As shown in FIG. 8, whenever possible, the certifiers 602 may process the transactions in set 702 in parallel. At 802, S 612 determines the synchronization constraint 144 it will pass to C₃. At 804, S 612 updates LastAssignedLSNMap(C₂)=3 to reflect its assignment of T₃ to C₂ (602c).

In the state shown in FIG. 8, at 806 C₁ (602b) is still processing T₂, at 808 C₂ (602c) completed processing T₃ and updated its variable LastProcessedLSN(C₂) (604c) to 3, and at 810, C₃ (602d) completed processing T₄ and updated its variable LastProcessedLSN(C₃) (604d) to 4.

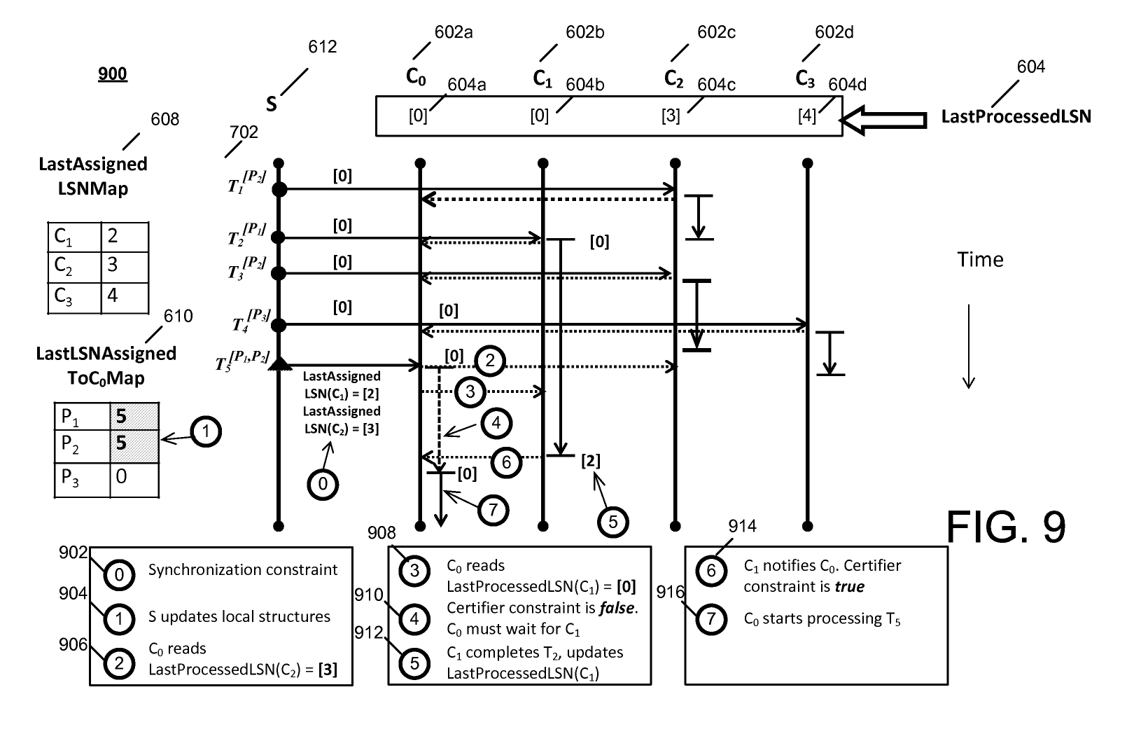

FIG. 9 illustrates an example processing 900 of a multi-partition transaction. For example, FIG. 9 illustrates the processing 900 of the first multi-partition transaction, T₅ (in set 702), which accesses partitions P₁ and P₂.

For multi-partition transactions, S 612 reads LastAssignedLSNMap 608 to determine the synchronization constraints and updates LastLSNAssignedToC₀Map 610 based on the partitions 110 accessed. C₀ (602a) synchronizes with the corresponding certifiers. In FIG. 9, T₅ accessed P₁ and P₂. When C₀ (602a) reads LastProcessedLSN(C₁) (604b), its current value ([0]) is less than that specified by the constraint 144. As such, C₀ (602a) waits until C₁ (602b) finishes processing T₂ (in set 702).

As shown in FIG. 9, S 612 assigns T₅ to C₀ (602a). At 902, S 612 specifies the synchronization constraint 144, which ensures that T₅ (in set 702) is processed after T₂ (the last single-partition transaction accessing P₁) and T₃ (the last single-partition transaction accessing P₂). S 612 reads LastAssignedLSNMap (C₁) and LastAssignedLSNMap(C₂) to determine the LSNs of the last single-partition transactions for C₁ and C₂, respectively. The synchronization 144 constraint shown at 902 corresponds to this indication, i.e., LastProcessedLSN(C₁)≧2 ΛLastProcessedLSN(C₂)≧3. S 612 passes the constraint to C₀ (602a) along with T₅. Then, at 904, S 612 updates LastLSNAssignedToC₀Map(P₁)=5 and LastLSNAssignedToC₀Map(P₂)=5 to reflect that T₅ is the last multi-partition transaction accessing P₁ and P₂. Any subsequent single-partition transaction accessing P₁ or P₂ will now follow the processing of T₅. At 906 and 908, C₀ (602a) reads LastProcessedLSN(C₂) (604c) and LastProcessedLSN(C₁) (604b) respectively to evaluate the constraint 144. At this point in time, C₁ (602b) is still processing T₂ and hence at 910, the constraint 144 evaluates to false. Therefore, even though C₂ (602c) has finished processing T₃, C₀ (602a) waits for C₁ (602b) to finish processing T₂. Once C₁ (602b) finishes processing T₂ at 912, it updates LastProcessedLSN(C₁) (604b) to 2. Now, at 914, C₁ (602b) notifies C₀ (602a) about this update. Thus, C₀ (602a) checks its constraint again and determines that it is satisfied. Therefore, at 916, it starts processing T₅.

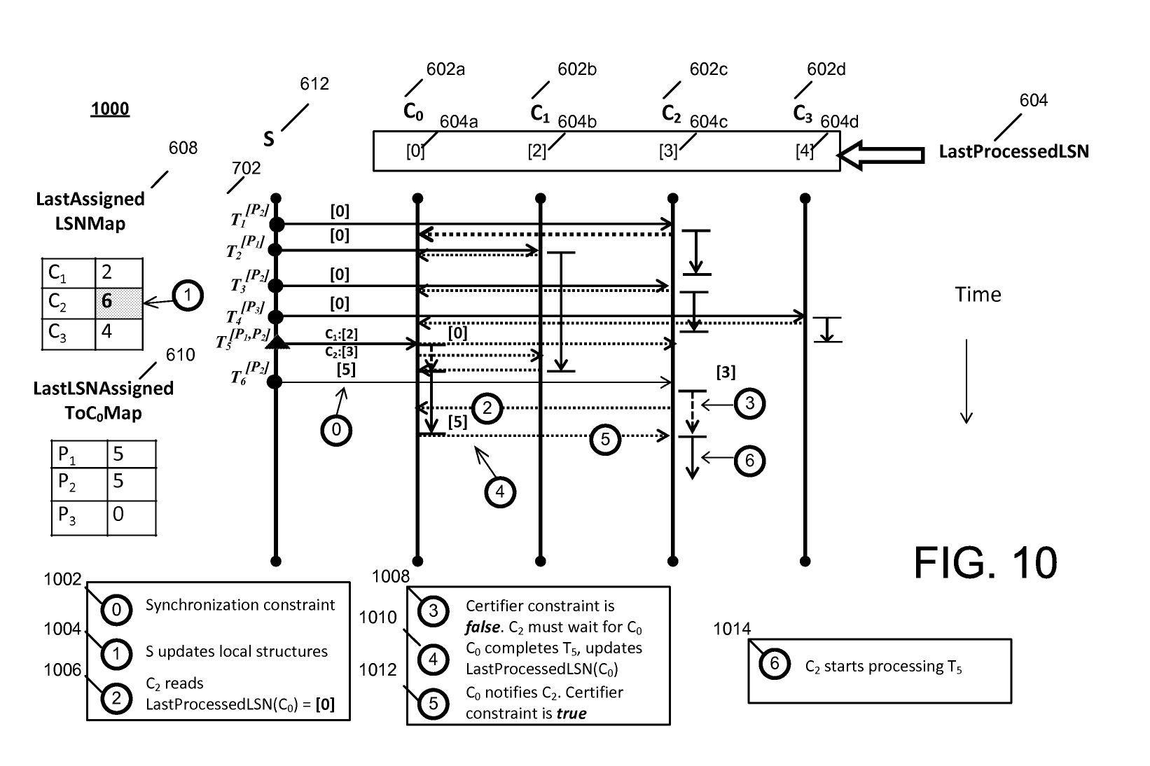

FIG. 10 illustrates an example processing 1000 of an example single-partition transaction. For example, FIG. 10 illustrates processing of the next transaction T₆, which is a single-partition transaction 106 that accesses P₂.

Transactions T₅ and T₆ access partition P₂ and hence will be processed sequentially even though T₅ is assigned to C₀ and T₆ is assigned to C₂. Since both T₅ and T₆ access P₂, T₆ can be processed by C₂ (602c) only after C₀ (602a) has finished processing T₅. Similar to other single-partition transactions, S 612 constructs this constraint 144 by looking up LastLSNAssignedToC₀Map(P₂) (610) which is 5. Therefore, at 1002, S 612 passes the constraint LastProcessedLSN(C₀)≧5 to C₂ (602a) along with T₆, and at 1004 sets LastLSNAssignedToC₀Map(P₂)=6. At 1006 C₂ (602b) reads LastProcessedLSN(C₀)=0. Thus, its evaluation of the constraint at 1008 yields false. C₀(602a) finishes processing T₅ at 1010 and sets LastProcessedLSN(C₀)=5. At 1012, C₀ (602a) notifies C₂ (602b) that it updated LastProcessedLSN(C₀) (604a), so C₂ (602c) checks the constraint 144 again and determines that it is true. Therefore, at 1014, it starts processing T₅.

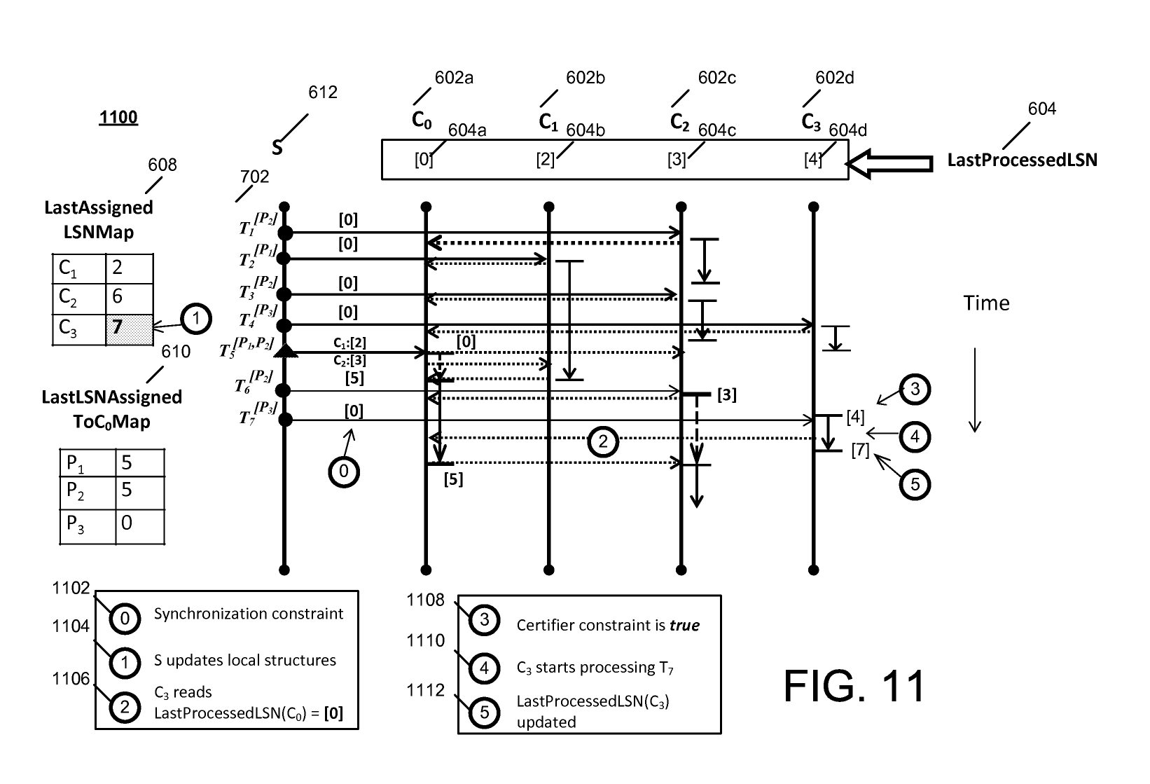

While C₂ is waiting for C₀, other certifiers can process subsequent transactions if the constraints allow it. FIG. 11 illustrates this scenario where the next transaction in the log, T₇, is a single-partition transaction accessing P₃.

While transaction T₆ is waiting for transaction T₅ to complete at C₀, C₃ can start processing transaction T₇ which does not conflict with either T₅ or T₆. Processing of T₇ finishes before that of T₆.

Since no multi-partition transaction preceding T₇ has accessed P₃, at 1102 the constraint 144 passed to C₃ (602d) is LastProcessedLSN(C₀)≧0. At 1104, S 612 updates local structures. At 1106, C₃ reads LastProcessedLSN(C₀) as zero. The constraint 144 is satisfied, which C₃ (602d) observes at 1108. Therefore, while C₂ is waiting, at 1110, C₃ starts processing T₇ in parallel with C₀'s processing of T₅ and C₂'s processing of T₆. At 1112, LastProcessedLSN(C₃) is updated.

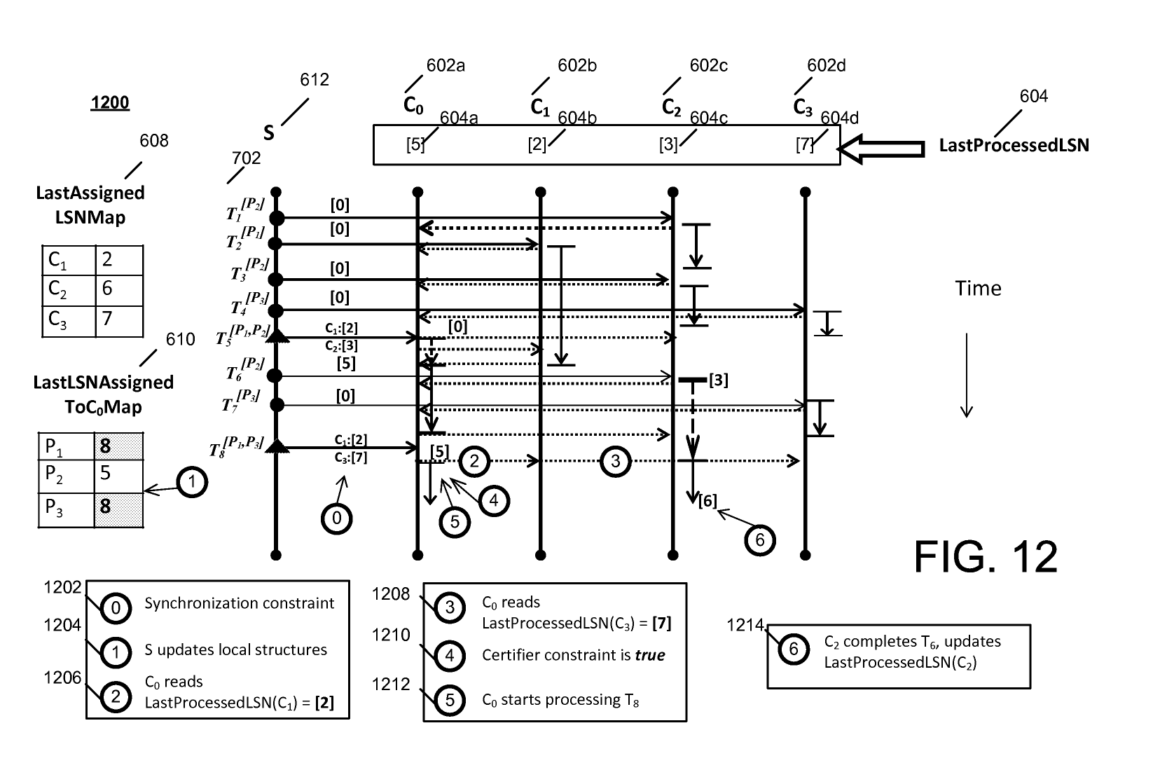

FIG. 12 illustrates example processing by a parallelized certifier. For example, FIG. 12 indicates that if the synchronization constraints 144 allow, even a multi-partition transaction can be processed in parallel with other single-partition transactions without waits. As certifiers 602 process the transactions in set 702, S 612 moves to the next transaction in the log. In FIG. 12, multi-partition transaction T₈ is assigned to C₀ while C₂ is still processing T₆. Since T₆ and T₈ do not access the same partitions, the synchronization constraint is satisfied and C₀ proceeds with execution without waiting for C₂.

Transaction T₈ accesses P₁ and P₃. At 1202, based on LastAssignedLSNMap 608, S 612 generates a constraint 144 of LastProcessedLSN(C₁)≧2 Λ LastProcessedLSN(C₃)≧7 and passes it along with T₈ to C₀(602a). At 1204, the local structures are updated. By the time C₀ (602a) starts evaluating its constraint 144, both C₁ (602b) and C₃ (602c) have completed processing the transactions of interest to C₀ (602a). Therefore, at 1206 and 1208, C₀ (602a) reads LastProcessedLSN(C₁)=2 and LastProcessedLSN(C₃)=7. Thus, at 1210 C₀ (602a) determines that the constraint 144 LastProcessedLSN(C₁)≧2 Λ LastProcessedLSN(C₃)≧7 is satisfied. Thus, it may immediately start processing T₈ at 1212, even though C₂ (602c) is still processing T₆.

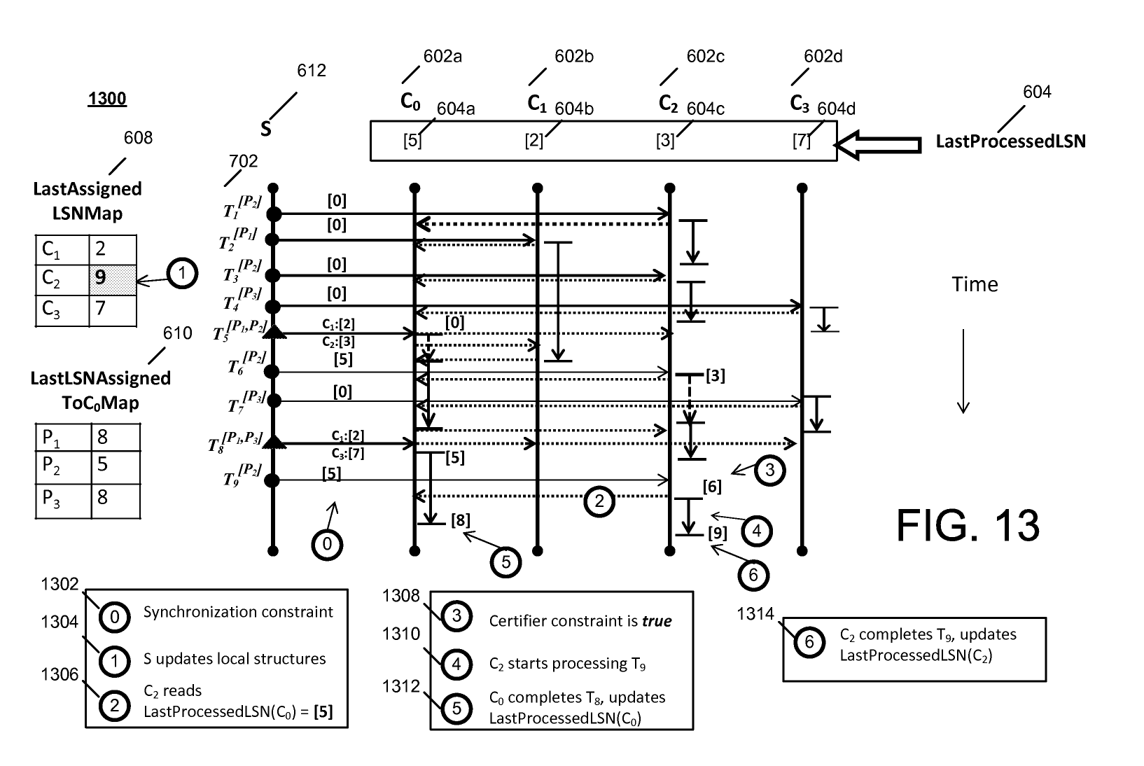

FIG. 13 illustrates example processing by a parallelized certifier. The parallel certifier 602 continues processing the transactions in set 702 in log order and the synchronization constraints 144 ensure correctness of the parallel design.

As shown in FIG. 13, S 612 processes the next transaction, T₉, which accesses only one partition, P₂. Although T₈ is still active at C₀ (602a) and hence blocking further activity on C₁ (602b) and C₃ (602d), by this time T₇ has finished running at C₂ (603c). Thus, when S 612 assigns T₉ to C₂ (602b) at 1302, C₂'s constraint is already satisfied at 1308, so C₂ (602c) can immediately start processing T₉ at 1310, in parallel with C₀'s processing of T₈. At 1304, S 612 updates local structures, and at 1306, C₂ reads LastProcessedLSN(C₀) as 5. Later, T₈ finishes at 1312 and T₉ finishes at 1314, thereby completing the execution.

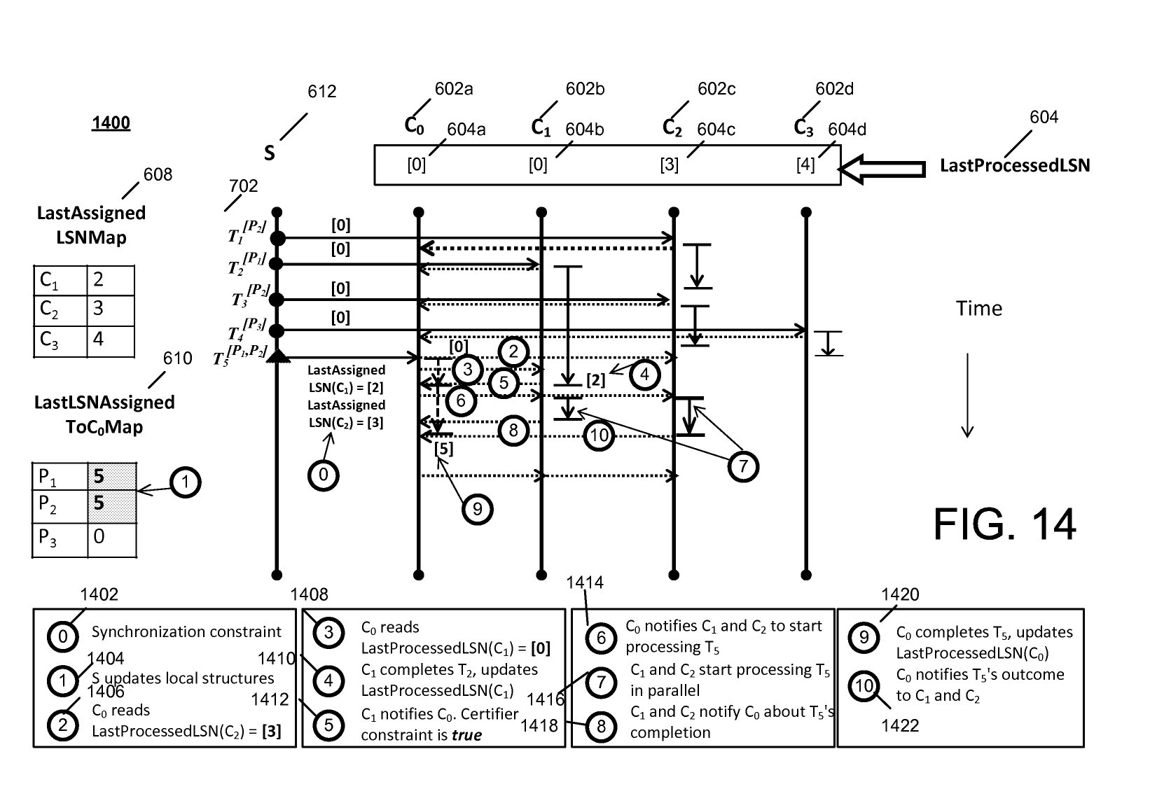

In accordance with example techniques discussed herein, processing of multi-partition transactions may also be parallelized across the certifiers corresponding to the partitions that the transaction accessed. FIG. 14 illustrates such parallelization. For example, parallel processing of multi-partition transactions may be orchestrated by C₀.

FIG. 14 illustrates an example processing 1400 of multi-partition transactions that is parallelized across certifiers. As an example, FIG. 14 may refer to the example transaction history 702 used in FIG. 13.

T₅ is a multi-partition transaction that accessed P₁ and P₂. Similar to the previous design as discussed above, C₀ (602a) will synchronize with C₁ (602b) and C₂ (602c) to enforce the ordering constraint that S 612 produces at 1402, namely that T₅ is processed after T₂ and T₃. Processing similar to previous processing occurs at 1404, 1406, 1408, and 1410. However, after the certification constraint 144 is satisfied at 1412, instead processing T₅ at C₀ (602a) while C₁ (602b) and C₂ (602c) are idle, S 612 may parallelize the processing of T₅ at 1414, 1416 by sending to C₁ (602b) the updates T₅ made to P₁ and sending to C₂ (602c) the updates T₅ made to P₂, as illustrated in FIG. 14. This parallelization may potentially further improve certification latency, especially for complex transactions that access multiple partitions.

However, this parallelism may incur a cost of higher communication overhead between the certifiers. This overhead may arise because C₁ (602b) and C₂ (602c) independently determine whether T₅ commits or aborts. However, they will both make the same commit-abort decision. Therefore, after both C₁ (602b) and C₂ (602c) have completed processing T₅ at 1420, C₀ (602a) determines whether the transaction committed at all the certifiers. If so, it notifies this result to C₁ (602b) and C₂ (602c), at 1422. If either certifier decided to abort, then C₀ (602a) instructs C₁ (602b) and C₂ (602c) to abort, even if one of them decided to commit. This synchronization between the certifiers is similar to the two-phase commit protocol for atomic commitment, where C₀ (602a) acts as the coordinator and C₁ (602b) and C₂ (602c) are the participants. In addition to the communication cost of two rounds of communication between C₀ (602a) and C₁/C₂, there is a two-phase-commit problem of blocking if C₁ or C₂ fails after the first round of communication. If the certifiers execute as separate threads in a single machine, this type of blocking scenario is unlikely. However, if they execute as processes on different machines, the probability of a blocking scenario is higher. In that case, the earlier technique of executing multi-partition transactions on C₀ (602a) may be advantageous.

Correctness may be assured if for each partition Pᵢ, all transactions that access Pᵢ are certified in log order. There are two cases, single-partition and multi-partition transactions.

The constraint on a single-partition transaction Tᵢ ensures that Tᵢ is certified after all multi-partition transactions that precede it in the log and that accessed Pᵢ. Synchronization conditions on multi-partition transactions ensure that Tᵢ is certified before all multi-partition transactions that follow it in the log and that accessed Pᵢ.

The constraint on a multi-partition transaction Tᵢ ensures that Tᵢ is certified after all single-partition transactions that precede it in the log and that accessed partitions {Pᵢ₁, Pᵢ₂, . . . } that Tᵢ accessed. Synchronization conditions on single-partition transactions ensure that for each Pⱼε{Pᵢ₁, Pᵢ₂, . . . }, Tᵢ is certified before all single-partition transactions that follow it in the log and that accessed Pⱼ.

Transactions that modify a given partition Pᵢ may be certified either on Cᵢ or C₀. However, only one of the certifiers is active on Pᵢ at any given time.

The extent of parallelism achieved by the example parallel certifiers described herein may depend on a partitioning that ensures most transactions access a single partition and that spreads transaction workload uniformly across the partitions. With a perfect partitioning, each certifier may have a dedicated core. Thus, with n partitions, a parallel certifier may run up to n times faster than a single sequential certifier.

Each of the variables that is used in a synchronization constraint—-LastAssignedLSNMap 608, LastProcessedLSN 604, and LastLSNAssignedToC₀Map 610, may be updatable by only one certifier. Therefore, there are no race conditions on these variables that involve synchronization between certifiers. The only synchronization points are the constraints on individual certifiers.

The parallelized certifier algorithm (602) generates constraints 144 under the assumption that certification of two transactions 106 that access the same partition 110 will be synchronized. This may be a conservative assumption, in that two transactions 106 that access the same partition 110 may access the same data item in non-conflicting modes, or may access different data items in the partition 110, which implies the transactions 106 do not conflict. Therefore, the synchronization overhead may be improved by finer-grained conflict testing. For example, in LastAssignedLSNMap 608, instead of storing one value for each partition 110 that identifies the LSN of the transaction assigned to the partition, two values may be stored, one that identifies the LSN of the last transaction that read the partition and was assigned to the partition, and one that identifies the LSN of the last transaction that wrote the partition and was assigned to the partition. A similar distinction may be made for the other variables. Thus, S 612 may generate a constraint 144 that may avoid scenarios in which a multi-partition transaction that only read partition Pᵢ is delayed by an earlier single-partition transaction that only read partition Pᵢ, and vice versa. The constraint 144 may still ensure that a transaction 106 that wrote Pᵢ is delayed by earlier transactions 106 that read or wrote Pᵢ, and vice versa.

This finer-grained conflict testing may not completely eliminate synchronization between C₀ and Cᵢ, even when a synchronization constraint is immediately satisfied. Synchronization may still be involved to ensure that only one of C₀ and Cᵢ is active on a partition Pᵢ at any given time, since conflict-testing within a partition is single-threaded. Aside from that synchronization, and the use of finer-grained constraints, the rest of the algorithm for parallelizing certification may remain the same.

According to example embodiments herein, finer-grained conflict testing may also be accomplished by defining sub-partitions within a partition. For example, an example partition Pᵢ may be split into sub-partitions Pᵢ₁ and Pᵢ₂. Similar to the case of distinguishing the last transaction that read a partition from the last transaction that wrote a partition, the algorithm may keep track of the last transaction that accessed sub-partition Pᵢ₁ from the last transaction that accessed sub-partition Pᵢ₂. Thus, S 612 may generate a constraint that may avoid requesting that a multi-partition transaction that accessed only sub-partition Pᵢ₁ be delayed by an earlier single-partition transaction that accessed only sub-partition Pᵢ₂, and vice versa.

Partitioning the database may also allow partitioning the log. For example, the log may be partitioned with partial ordering of transactions.

For example, there may be one log Lᵢ (134b-134n) dedicated to every partition Pᵢ (∀i ε[1, n]) (110a-110n) storing transaction objects (e.g., intentions) for single-partition transactions 106 accessing Pᵢ, and one log L₀ (134a) dedicated to storing the intentions for multi-partition transactions 106. If a transaction Tᵢ accesses only Pᵢ, its intention may be appended to Lᵢ without communicating with any other log. If Tᵢ accessed multiple partitions {Pᵢ}, its intention may be appended to L₀ (134a) followed by communication with all logs {Lᵢ} (134b-134n) corresponding to {Pᵢ} (110a-110n).

According to an example embodiment, the log protocol may be executed by the server that processes each transaction. Alternatively, according to an example embodiment, the log protocol may be embodied in a log server, which receives requests to append intentions from servers that run transactions.

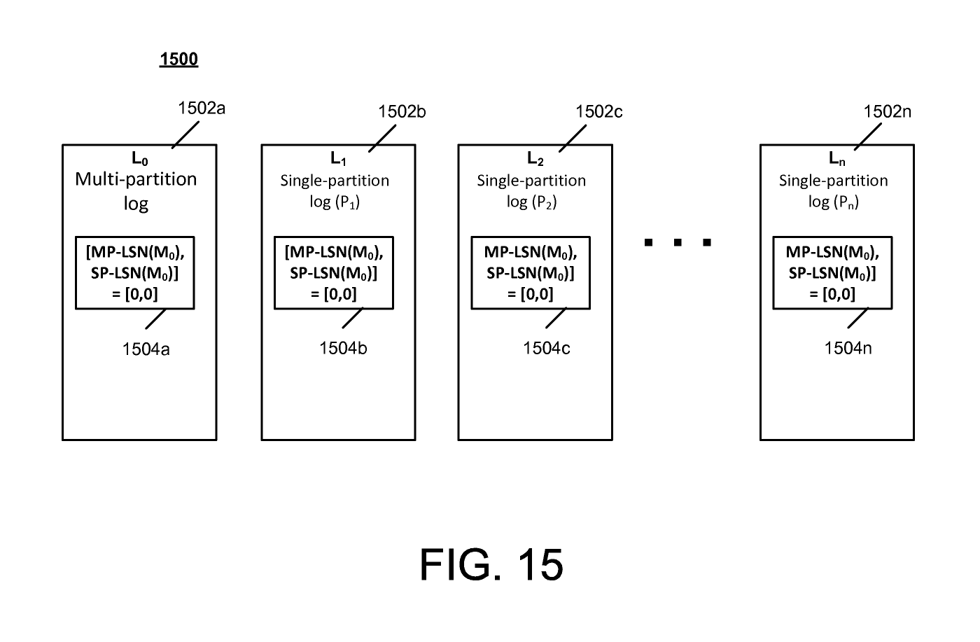

FIG. 15 illustrates example log sequence numbers used in an example partitioned log design 1500. According to an example embodiment, a technique similar to vector clocks may be used for sequence-number generation. Each log Lᵢ (1502) for iε[1, n] may maintain the single partition LSN of Lᵢ, denoted SP-LSN(Lᵢ), which is the LSN of the last single-partition log record appended to Lᵢ. To order single-partition transactions with respect to multi-partition transactions, every log 1502 also maintains the multi-partition LSN of Lᵢ, denoted MP-LSN(Lᵢ), which is the LSN of the last multi-partition transaction that accessed Pᵢ and is known to Lᵢ. A sequence number 1504 of each record Rₖ in log Lᵢ for iε[1, n] may be expressed as a pair of the form [MP-LSNₖ(Lᵢ), SP-LSNₖ(Lᵢ)]. The sequence number 1504 of each record Rₖ in log L₀ is of the form [MP-LSNₖ(Lᵢ), 0], i.e., the second position may always be zero. All logs 1502 may start with sequence number [0,0].

For example, each log Lᵢ (1502) may maintain a compound LSN ([MP-LSN(Lᵢ), SP-LSN(Li)]) (1504) to induce a partial order across conflicting entries in different logs.

According to an example embodiment, the order of two sequence numbers may be decided by first comparing MP-LSN(Lᵢ) and then SP-LSN(Lᵢ). That is, [MP-LSNⱼ(Lᵢ), SP-LSNⱼ(Lᵢ)] precedes [MP-LSNₖ(Lᵢ), SP-LSNₖ(Lᵢ)] if either MP-LSNⱼ(Lᵢ)<MP-LSNₖ(Lᵢ), or (MP-LSNⱼ(Lᵢ)=MP-LSNₖ(Lᵢ) and SP-LSNⱼ(Lᵢ)<SP-LSNₖ(Lᵢ)). This example technique may totally order intentions (e.g., records) in the same log, while partially ordering intentions of two different logs. If the ordering between two intentions is not defined, then they may be treated as concurrent. According to an example embodiment, LSNs in different logs may be incomparable, as their SP-LSN's are independently assigned.

In a context of single-partition transactions, if an example transaction Tᵢ accessed a single partition Pᵢ, then Tᵢ's intention may be appended only to Lᵢ, according to an example embodiment. SP-LSN(Lᵢ) may be incremented and the LSN of Tᵢ's intention may be set to [mp-lsn, SP-LSN(Lᵢ)], where mp-lsn represents the latest value of MP-LSN(L₀) it has received from L₀.

In a context of multi-partition transactions, if Tᵢ accessed multiple partitions {Pᵢ₁, Pᵢ₂, . . . }, then Tᵢ's intention may be appended to log L₀ and the multi-partition LSN of L₀, MP-LSN(L₀), may be incremented, according to an example embodiment. After these actions finish, MP-LSN(L₀) may be passed to all logs {Lᵢ₁, Lᵢ₂, . . . } (1502) corresponding to {Pᵢ₁, Pᵢ₂, . . . }, which completes Tᵢ's append.

This example technique of log-sequencing enforces a causal order between the log entries. Thus, two log entries may have a defined order only if they accessed the same partition.

According to an example embodiment, each log Lᵢ (∀iε[1, n]) may maintain MP-LSN(Lᵢ) as the largest value of MP-LSN(L₀) it has received from L₀ so far. However, according to an example embodiment, the Lᵢ's may not store its MP-LSN(Lᵢ) persistently. For example, if Lᵢ fails and then recovers, it may obtain the latest value of MP-LSN(L₀). For example, it may obtain this value by examining L₀'s tail. This examination of L₀'s tail may seemingly be avoided by having Lᵢ log each value of MP-LSN(L₀) that it receives; however, while this does potentially enable Lᵢ to recover further without accessing L₀'s tail, it may not avoid that examination entirely.

For example, if the last transaction that accessed Pᵢ before Lᵢ failed was a multi-partition transaction that succeeded in appending its intention to L₀, but Lᵢ did not receive the MP-LSN(L₀) for that transaction before Lᵢ failed, then, after Lᵢ recovers, it may still wait to receive that value of MP-LSN(L₀), which it may do only by examining L₀'s tail. If L₀ has also failed, then after recovery, Lᵢ may continue with the highest known value of MP-LSN(L₀) without waiting for L₀ to recover. As a result, a multi-partition transaction may be ordered in Lᵢ at a later position than where it would have been ordered if the failure did not happen.

Alternatively, for each multi-partition transaction, L₀ may run two-phase commit with the logs corresponding to the partitions that the transaction accessed. For example, it may send MP-LSN(L₀) to those logs and wait for acknowledgments from all of them before logging the transaction at L₀. However, this example technique has a possibility of blocking if a failure occurs between phases one and two.

To avoid this blocking, according to an example embodiment, when L₀ recovers, it may communicate with all of the Lᵢ to pass the latest value of MP-LSN(L₀). When one of Lᵢ recovers, it may read the tail of L₀. This example recovery technique may ensure that MP-LSN(L₀) propagates to all single-partition logs.

As an example, a database may include three partitions (110) P₁, P₂, P₃. For example, L₁, L₂, L₃ may be logs 134 assigned to P₁, P₂, P₃ respectively, and L₀ may be the log for multi-partition transactions. For this example, a sequence of transactions may include:
T₁^{[P}^{₂}^{]}, T₂^{[P}^{₁}^{]}, T₃^{[P}^{₂}^{]}, T₄^{[P}^{₃}^{]}, T₅^{[P}^{₁}^{, P}^{₂}^{]}, T₆^{[P}^{₂}^{]}, T₇^{[P}^{₃}^{]}, T₈^{[P}^{₁}^{, P}^{₃}^{]}, T₉^{[P}^{₂}^{]}

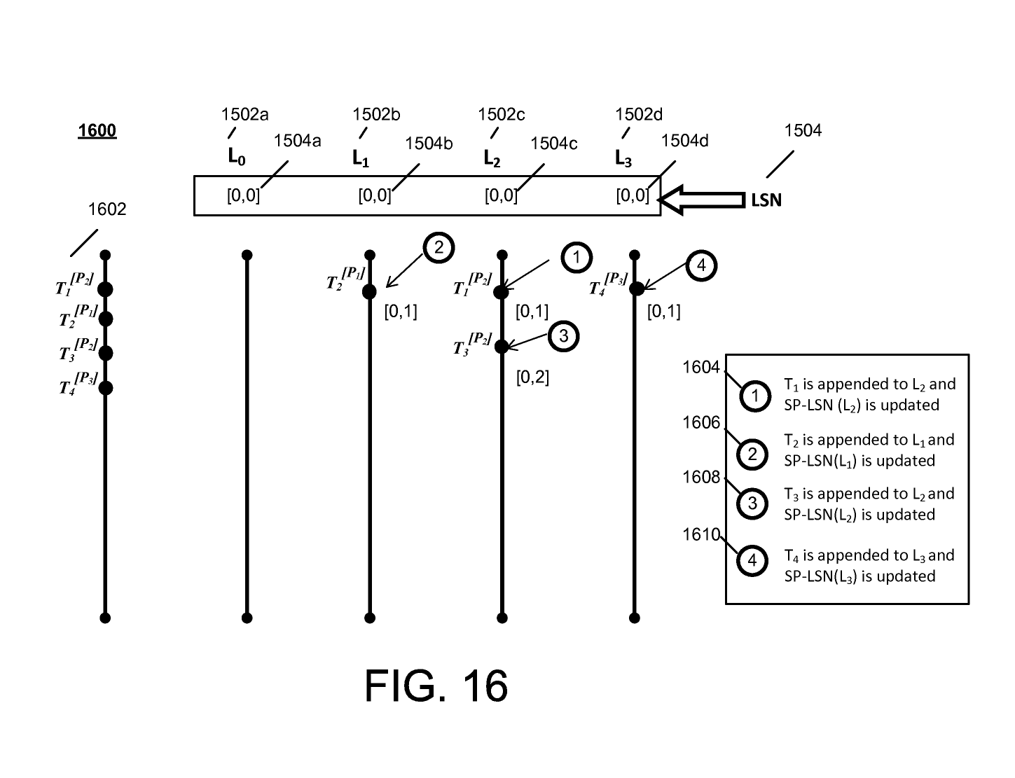

For example, a transaction may be more formally represented in the form Tᵢ^{[P}^{ⱼ}^{]} where i is an identifier assigned to a transaction and [Pⱼ] is a set of partitions that Tᵢ accesses. The transaction identifier i may not induce an ordering between the transactions. Since a transaction is identified using its id in this example, transactions may be referenced as Tᵢ for brevity. As used herein, Tᵢ may refer to both a transaction and its intention. As shown in FIGS. 16-20 discussed below, a vertical line at an extreme left of FIGS. 16-20 indicates an order in which append requests 1602 arrive.

FIG. 16 illustrates four single-partition transactions T₁, T₂, T₃, T₄ 1602 that are appended to the logs (1502a-1502d) corresponding to the partitions 110 where the transactions accessed data. The numbers \textcircled{1}-\textcircled{4} (1604, 1606, 1608, 1610) identify points in the execution. When appending a transaction, the log's SP-LSN may be incremented. For example, in FIG. 16, T₁ is appended to L₂ at 1604, which changes L₂'s LSN (1504c) from [0,0] to [0,1]. Similarly at 1606, 1608, 1610, the intentions for T₂-T₄ are appended and the SP-LSN 1504 of the appropriate log is incremented. Since appends of single-partition transactions do not need synchronization between the logs, such append operations may proceed in parallel without any ordering; an order may be induced only between transactions appended to the same log. For example, T₁ and T₃ both access partition P₂ and hence are appended to L₂ with T₁ (at 1604) preceding T₃ (at 1608); however, the relative order of T₁, T₂, and T₄ is undefined.

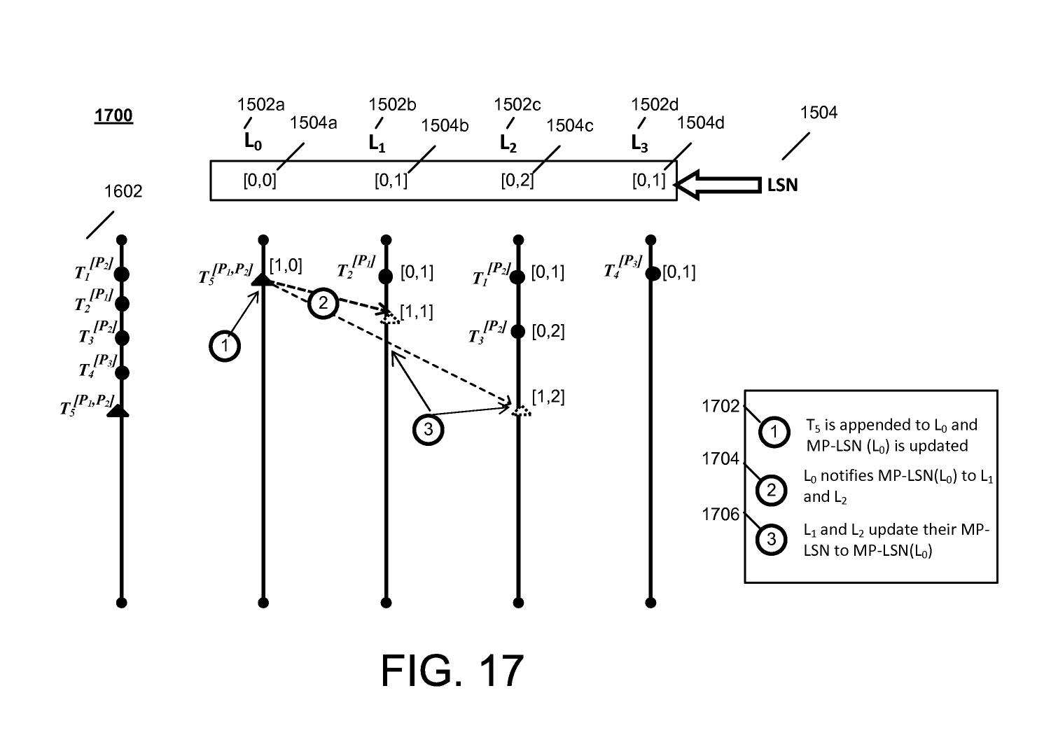

Multi-partition transactions result in loose synchronization between the logs to induce an ordering among transactions appended to the different logs. FIG. 17 illustrates an example multi-partition transaction T₅ that accessed P₁ and P₂. A multi-partition transaction is appended to L₀ and MP-LSN(L₀) may be passed to the logs for the partitions accessed by the transaction. In this example, T₅ accessed P₁ and P₂ and the MP-LSN(L₀) is passed only to L₁ and L₂. In this example, L₁ and L₂ do not append the new value of MP-LSN(L₀) to their individual logs.

When T₅'s intention is appended to L₀ (at 1702), MP-LSN(L₀) is incremented to 1. In step 1704, the new value of MP-LSN(L₀)=1, which is sent to L₁ (1502b) and L₂ (1502c). On receipt of this new LSN (at 1706), L₁ (1502b) and L₂ (1502c) update their corresponding MP-LSN, e.g., L₁'s LSN (1504b) is updated to [1,1] and L₂'s LSN (1502c) is updated to [1,2]. As an optimization, this updated LSN 1504 may not be persistently stored in L₁ (1502b) or L₂ (1502c). In case of a failure of either log, this latest value may be obtained from L₀ (1502a) that stores it persistently.

Any subsequent single-partition transaction appended to either L₁ (1502b) or L₂ (1502c) may be ordered after T₅, thus establishing a partial order with transactions appended to L₀.

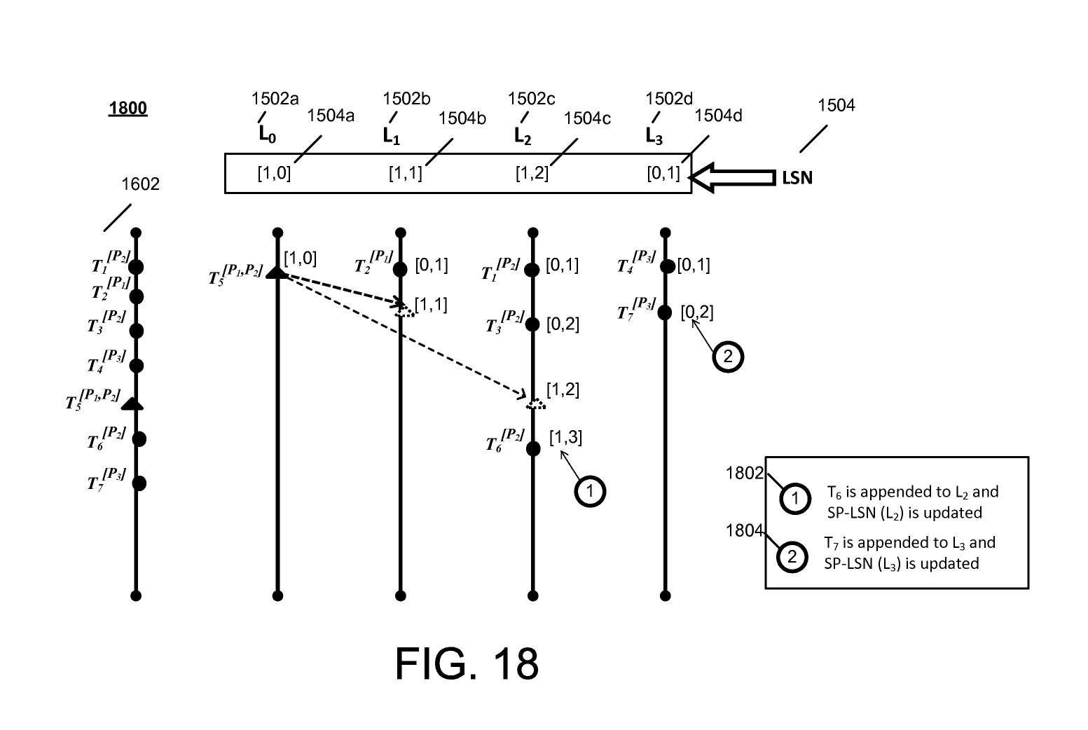

FIG. 18 illustrates single-partition transactions that follow a multi-partition transaction, persistently storing the new value of MP-LSN(Lᵢ) in Lᵢ. In this example, only L₂ has a persistent copy of the latest MP-LSN(L₂) due to the append of T₆ while MP-LSN(L₁) is still in volatile storage.

As shown in FIG. 18, T₆ is a single-partition transaction accessing P₂ which, when appended to L₂ (at 1802), establishes an order T₃<T₅<T₆. As a side-effect of appending T₆'s intention, MP-LSN(L₂) (1504c) may be persistently stored as well. T₇, another single-partition transaction accessing P₃, may be appended to L₃ (1502d) at 1804. It is concurrent with all transactions except T₄, which was appended to L₃ (1502d) before T₇.

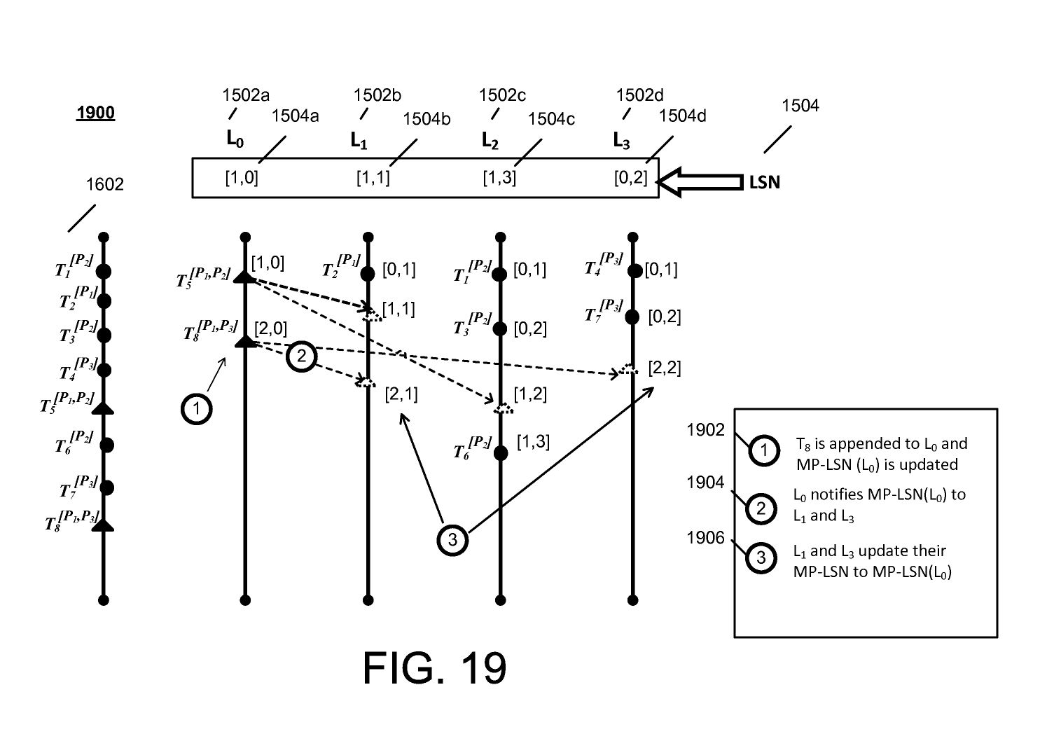

FIG. 19 illustrates processing of an example multi-partition transaction T₅ which accesses partitions P₁ and P₃. In this example, different logs may advance their LSNs 1504 at different rates. A partial order may be established by the multi-partition transactions. After T₈ is appended, entries in L₁ (1502b) and L₃ (1502c) have a partial order.

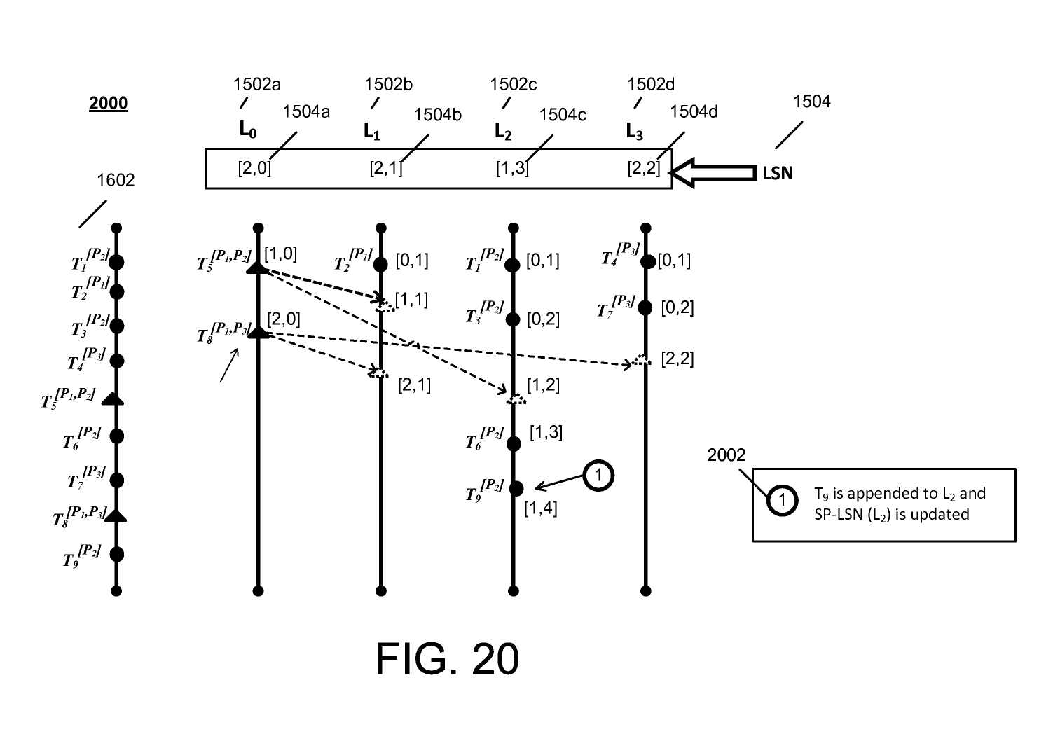

Similar to the steps shown in FIG. 18, T₅ is appended to L₀ (at 1902) and MP-LSN(L₀) (1504a) is updated. The new value of MP-LSN(L₀) (1504a) is passed to L₁ (1502b) and L₃ (1502c) (at 1904) after which the logs 1502 update their corresponding MP-LSN (1504) (at 1906). T₅ induces an order between multi-partition transactions appended to L₀ (1502a) and subsequent transactions accessing P₁ and P₃. The partitioned log design continues processing transactions as described, establishing a partial order between transactions as and when needed. FIG. 20 illustrates an example append of a next single-partition transaction T₉ appended to L₂ (1502c) (at 2002). Thus, the example partitioned log technique may continue appending single-partition transactions without synchronizing with other logs.

According to an example embodiment, to ensure that multi-partition transactions have a consistent order across all logs, a new intention may be appended to L₀ only after the previous append to L₀ (1502a) has completed, e.g., the new value of MP-LSN(L₀) has propagated to all the single-partition logs corresponding to the partitions accessed by the transaction. This sequential appending of transactions to L₀ (1502a) may increase the latency of multi-partition transactions. A simple extension can allow parallel appends to L₀, simply by ensuring that each log partition retains only the largest MP-LSN(L₀) that it has received so far. According to an example embodiment, if a log Lᵢ receives values of MP-LSN(L₀) out of order, it may ignore the stale value that arrives late. For example, if a multi-partition transaction Tᵢ is appended to L₀ followed by another multi-partition transaction Tᵢ, which have MP-LSN(L₀)=1 and MP-LSN(L₀)=2, respectively, and if log Lᵢ receives MP-LSN(L₀)=2 and later receives MP-LSN(L₀)=1, then in this case, Lᵢ may ignore the assignment MP-LSN(L₀)=1, since it is a late-arriving stale value.

With a sequential certification algorithm, the logs may be merged by each compute server. A multi-partition transaction Tᵢ may be sequenced immediately before the first single-partition transaction Tⱼ that accessed a partition Tᵢ accessed and was appended with Tᵢ's MP-LSN(L₀). To ensure all intentions are ordered, each LSN may be augmented with a third component, which is its partition ID, so that two LSNs with the same multi-partition and single-partition LSN may be ordered by their partition ID.

With the parallel certifier 602, the scheduler S 140 may add constraints 144 to the transactions 106. As an example, for each log Lᵢ (134), and for each multi-partition LSN MP-LSN(Lᵢ), the first transaction with MP-LSN(Lᵢ) may have the constraint LastProcessedLSN(C₀)≧MP-LSN(Lᵢ). In L₀, for each transaction T with multi-partition LSN MP-LSN(L₀), if T accessed partitions {Pᵢ}, then it may have the constraint Λ_{∀j:P}_{ⱼ}_{ε{P}_{ᵢ}_{}} LastProcessedLSN(Cⱼ)≧Xⱼ, where Xⱼ is the LSN of the last intention in Pⱼ with MP-LSN(L₀). These constraints may be deduced from the logs 134, so storage of these constraints in the logs may be avoided.

According to example embodiments discussed herein, the partitioned log behaves the same as a non-partitioned log. For sequential certification, the partitioned log may be merged into a single non-partitioned log, so the result follows immediately. For parallel certification, for each log Lᵢ (i≠0), the constraints may ensure that each multi-partition transaction is synchronized between L₀ (134a) and Lᵢ (134b-134n) in substantially the same way as in the single log case.

If most of the transactions access only a single partition and there is enough network capacity, example partitioned log techniques discussed herein may provide a nearly linear increase in log throughput as a function of the number of partitions.

Example techniques referred to herein as “Hyder” may involve a database architecture that scales-out without partitioning, as discussed in greater detail in Philip A. Bernstein, et al., “Hyder—A Transactional Record Manager for Shared Flash,” Conference on Innovative Database Research, 2011, pp. 9-20. In accordance with example Hyder techniques, the log is the database and may be stored as a multi-version binary search tree. For example, transactions may execute on a snapshot of the database and the set of updates made by a transaction, referred to herein as its intention record, may be stored as an after-image in the log. An example certification algorithm, referred to herein as “Meld,” as discussed in greater detail in Philip A. Bernstein, et al., “Optimistic Concurrency Control by Melding Trees,” Proceedings of the VLDB Endowment (PVLDB), vol. 4(11) (2011), pp. 944-955, reads intentions from the log and sequentially processes them in log order to determine whether a transaction committed or aborted.

Given an approximate partitioning of the database, the parallel certification and partitioned log algorithms described in the “Meld” document, supra, may be directly applied to Hyder. For example, each parallel certifier may run the Meld algorithm, and each log partition may function as an ordinary Hyder log storing updates to that partition. For example, each log may store the after-image of the binary search tree generated by transactions updating the corresponding partition. Multi-partition transactions may result in a single intention record that stores the after-image of all partitions, though this multi-partition intention may be split so that a separate intention is generated for every partition.

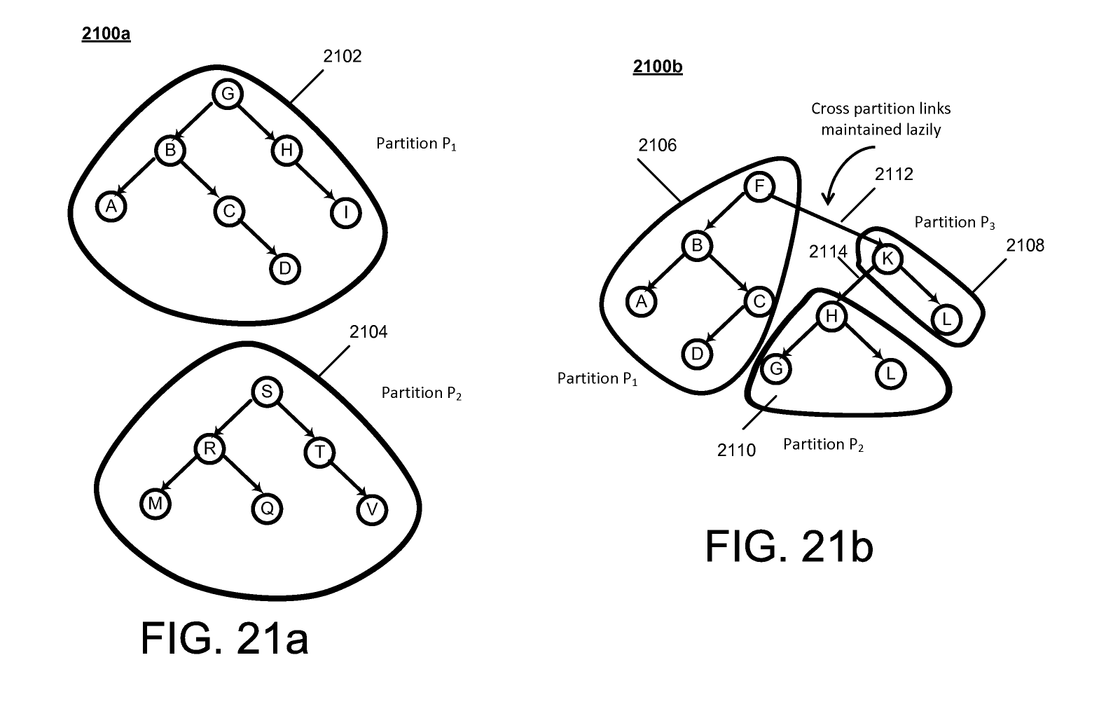

FIG. 21 illustrates an example partitioning 2100 of a database in accordance with Hyder. According to an example embodiment, the application of approximate partitioning to Hyder may assume that the partitions are independent trees, as shown in FIG. 21(a). Directory information may be maintained that describes which data is stored in each partition. During transaction execution, the executer may track the partitions accessed by the transaction. This information may be included in the transaction's intention, which may be used by the scheduler 140 to parallelize certification, and by the log partitioning algorithm.

In addition to an example Hyder design where all compute nodes run transactions (on all partitions), it may be possible for a given compute node to serve only a subset of the partitions, according to an example embodiment. However, this may increase the cost of multi-partition transaction execution and meld.

An example technique using a partitioned tree, as shown in FIG. 21(b), is also possible, though at a cost of increased complexity. For example, cross-partition links may be maintained as logical links, to allow single-partition transactions to proceed without synchronization and to minimize the synchronization for maintaining the database tree. For example, in FIG. 21(b), the link 2112 between partitions P₁ (2106) and P₃ (2108) may be specified as a link from node F to the root K of P₃ (2108). Since single-partition transactions on P₃ (2108) modify P₃'s root, traversing this link (2112) from F may involve a lookup of the root of partition P₃ (2108). This link (2112) may be updated during meld of a multi-partition transaction accessing P₁ (2106) and P₃ (2108) and results in adding an ephemeral node replacing F if F's left sub tree was updated concurrently with the multi-partition transaction. The generation of ephemeral nodes is explained in Philip A. Bernstein, et al., “Optimistic Concurrency Control by Melding Trees, PVLDB, vol. 4(11) (2011), pp. 944-955. FIG. 21(b) shows a single database tree divided into partitions with inter-partition links (e.g., links 2112, 2114) maintained lazily.

Customer privacy and confidentiality have been ongoing considerations in data processing environments for many years. Thus, example techniques for processing database transactions may use user input and/or data provided by users who have provided permission via one or more subscription agreements (e.g., “Terms of Service” (TOS) agreements) with associated applications or services associated with processing database transactions. For example, users may provide consent to have their input/data transmitted and stored on devices, though it may be explicitly indicated (e.g., via a user accepted text agreement) that each party may control how transmission and/or storage occurs, and what level or duration of storage may be maintained, if any.

Implementations of the various techniques described herein may be implemented in digital electronic circuitry, or in computer hardware, firmware, software, or in combinations of them (e.g., an apparatus configured to execute instructions to perform various functionality). Implementations may be implemented as a computer program embodied in a propagated signal or, alternatively, as a computer program product, i.e., a computer program tangibly embodied in an information carrier, e.g., in a machine usable or machine readable storage device (e.g., a magnetic or digital medium such as a Universal Serial Bus (USB) storage device, a tape, hard disk drive, compact disk, digital video disk (DVD), etc.), for execution by, or to control the operation of, data processing apparatus, e.g., a programmable processor, a computer, or multiple computers. A computer program, such as the computer program(s) described above, can be written in any form of programming language, including compiled, interpreted, or machine languages, and can be deployed in any form, including as a stand-alone program or as a module, component, subroutine, or other unit suitable for use in a computing environment. The computer program may be tangibly embodied as executable code (e.g., executable instructions) on a machine usable or machine readable storage device (e.g., a computer-readable medium). A computer program that might implement the techniques discussed above may be deployed to be executed on one computer or on multiple computers at one site or distributed across multiple sites and interconnected by a communication network.

Method steps may be performed by one or more programmable processors executing a computer program to perform functions by operating on input data and generating output. The one or more programmable processors may execute instructions in parallel, and/or may be arranged in a distributed configuration for distributed processing. Example functionality discussed herein may also be performed by, and an apparatus may be implemented, at least in part, as one or more hardware logic components. For example, and without limitation, illustrative types of hardware logic components that may be used may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT), liquid crystal display (LCD), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback. For example, output may be provided via any form of sensory output, including (but not limited to) visual output (e.g., visual gestures, video output), audio output (e.g., voice, device sounds), tactile output (e.g., touch, device movement), temperature, odor, etc.

Further, input from the user can be received in any form, including acoustic, speech, or tactile input. For example, input may be received from the user via any form of sensory input, including (but not limited to) visual input (e.g., gestures, video input), audio input (e.g., voice, device sounds), tactile input (e.g., touch, device movement), temperature, odor, etc.

Further, a natural user interface (NUI) may be used to interface with a user. In this context, a “NUI” may refer to any interface technology that enables a user to interact with a device in a “natural” manner, free from artificial constraints imposed by input devices such as mice, keyboards, remote controls, and the like.

Examples of NUI techniques may include those relying on speech recognition, touch and stylus recognition, gesture recognition both on a screen and adjacent to the screen, air gestures, head and eye tracking, voice and speech, vision, touch, gestures, and machine intelligence. Example NUI technologies may include, but are not limited to, touch sensitive displays, voice and speech recognition, intention and goal understanding, motion gesture detection using depth cameras (e.g., stereoscopic camera systems, infrared camera systems, RGB (red, green, blue) camera systems and combinations of these), motion gesture detection using accelerometers/gyroscopes, facial recognition, 3D displays, head, eye, and gaze tracking, immersive augmented reality and virtual reality systems, all of which may provide a more natural interface, and technologies for sensing brain activity using electric field sensing electrodes (e.g., electroencephalography (EEG) and related techniques).

Implementations may be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of such back end, middleware, or front end components. Components may be interconnected by any form or medium of digital data communication, e.g., a communication network. Examples of communication networks include a local area network (LAN) and a wide area network (WAN), e.g., the Internet.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
a multi-partitioned database certifier embodied via executable instructions stored on a machine readable storage device, the multi-partitioned database certifier including:
at least one device processor configured to execute at least a portion of the executable instructions stored on the machine readable storage device;
a certification component configured to initiate certification, in parallel, of transactions on shared data stored in database partitions included in an approximate database partitioning arrangement, based on initiating a plurality of certification algorithm executions in parallel, and providing a sequential certifier effect;
a log management component configured to initiate logging operations associated with a plurality of log partitions configured to store transaction objects associated with each respective transaction, each respective database partition included in the approximate database partitioning being associated with one or more of the log partitions; and
a scheduler configured to assign each of the transactions to a selected one of the certification algorithm executions,
the plurality of log partitions including a first log partition that stores a first set of the transaction objects that are associated with transactions that each access shared data that is stored in a plurality of the database partitions, and a plurality of second log partitions that each store transaction objects associated with respective ones of the transactions that each access shared data that is stored in only a respective single associated one of the database partitions.

2. The system of claim 1, wherein:
the first log partition includes a multi-database-partition log partition configured to store the first set of transaction objects that are associated with respective ones of the transactions that each access shared data that is stored in the plurality of the database partitions, and the plurality of second log partitions includes a set of single-database partition log partitions, each configured to store transaction objects associated with the respective ones of the transactions that each access shared data that is stored in single associated ones of the database partitions.

3. The system of claim 1, wherein:
each one of the transaction objects includes a transaction description that includes one or more indicators associated with descriptions of operations performed by the respective transaction on the shared data, and
each one of the certification algorithm executions is configured to sequentially analyze the descriptions of the operations performed by respective transactions assigned to the each one of the certification algorithm executions, in an order in which the descriptions of the operations are stored in an associated log partition, the analysis based on determining conflicts between pairs of the descriptions of the operations.

4. The system of claim 3, wherein determining conflicts between pairs of the descriptions of the operations includes one or more of:
determining whether a relative order in which the operations associated with the descriptions execute modifies a value of a shared data item, or
determining whether a relative order in which the operations associated with the descriptions execute affects a value returned by one of the operations associated with the descriptions.

5. The system of claim 1, further comprising:
a certification constraint determination component configured to determine certification constraints indicating certification ordering of sets of the transactions, based on determining database partition accesses associated with respective ones of the transactions, wherein:
the scheduler is configured to assign each of the transactions and associated constraint objects to the selected one of the certification algorithm executions, the constraint objects indicating the determined certification constraints, based on retrieving stored transaction objects from respective associated log partitions.

6. The system of claim 5, wherein:
each selected one of the certification algorithm executions is configured to process each pair of the transactions assigned to the selected one, that access a same database partition, in an ordering in which the transaction objects associated with the each pair of transactions are stored in each respective log partition that is associated with the same accessed database partition.

7. The system of claim 1, wherein:
each of the transaction objects includes information indicating one or more execution operations associated with each respective associated transaction.

8. The system of claim 1, wherein:
the plurality of certification algorithm executions include a multi-partition certification algorithm execution configured to certify transactions that access shared data that is stored in a plurality of the database partitions, and a set of single-partition certification algorithm executions, each configured to certify transactions that access shared data that is stored in a single associated one of the database partitions, wherein:
the scheduler is configured to assign each of the transactions to the selected one of the certification algorithm executions, based on determining shared data access attributes associated with the respective transactions.

9. The system of claim 1, wherein the plurality of certification algorithm executions includes one or more of:
a first group of the certification algorithm executions implemented via a plurality of threads within a single process,
a second group of the certification algorithm executions implemented via a plurality of processes co-located at a same computing device, or
a third group of the certification algorithm executions distributed across a plurality of different computing devices.

10. The system of claim 1, wherein:
the plurality of certification algorithm executions determine a respective commit status associated with each of the respective transactions, wherein:
the scheduler is configured to store last assigned log sequence numbers associated with single-partition certification algorithm executions in a first map, and last assigned log sequence numbers associated with a multi-partition certification algorithm execution in a second map.

11. The system of claim 1, wherein:
the plurality of certification algorithm executions includes a plurality of Meld certification algorithm executions, and
the plurality of log partitions include a plurality of Hyder logs.

12. A method comprising:
initiating logging operations associated with a plurality of log partitions configured to store transaction objects associated with transactions on shared data stored in database partitions included in an approximate database partitioning arrangement, each respective database partition included in the approximate database partitioning being associated with one or more of the log partitions, the logging operations based on mapping the transaction objects to respective log partitions corresponding to respective database partitions accessed by respective transactions associated with the respective mapped transaction objects, the transaction objects associated with transaction certification ordering attributes; and
initiating certification of the transactions on the shared data stored in the database partitions, based on receiving certification requests from a scheduler, based on the transaction certification ordering attributes, based on accessing the transaction objects stored in the plurality of log partitions, in an ordering of storage in the respective log partitions,
the plurality of log partitions including a first log partition that stores a first set of the transaction objects that are associated with transactions that each access shared data that is stored in a plurality of the database partitions, and a plurality of second log partitions that each store transaction objects associated with respective ones of the transactions that each access shared data that is stored in only a respective single associated one of the database partitions.

13. The method of claim 12, wherein:
the first log partition includes a multi-database-partition log partition configured to store the first set of transaction objects that are associated with respective ones of the transactions that each access shared data that is stored in the plurality of the database partitions, and the plurality of second log partitions includes a set of single-database partition log partitions, each configured to store transaction objects associated with the respective ones of the transactions that each access shared data that is stored in single associated ones of the database partitions.

14. The method of claim 12, wherein:
the transaction certification ordering attributes represent relative orderings of database processing of sets of the transactions on the shared data stored in the database partitions.

15. The method of claim 12, further comprising:
initiating a merging operation configured to merge the plurality of log partitions into a sequential transaction log, wherein:
initiating the certification of the transactions on the shared data stored in the database partitions includes initiating a sequential certification of the transactions on the shared data stored in the database partitions, based on receiving certification requests from a scheduler, and based on the transaction certification ordering attributes, and based on accessing the transaction objects stored in the sequential transaction log, and based on the ordering of storage in the respective log partitions.

16. The method of claim 12, wherein:
initiating the certification of the transactions on the shared data stored in the database partitions includes initiating the certification, in parallel, based on initiating a plurality of certification algorithm executions in parallel, and providing a sequential certifier effect, based on receiving the certification requests from the scheduler, and based on the transaction certification ordering attributes, and based on accessing the transaction objects stored in the log partitions, in an ordering of storage in the respective log partitions.

17. A computer program product tangibly embodied on a machine readable storage device and including executable code that is configured to cause at least one data processing apparatus to:
assign each of a plurality of transactions on shared data, that is stored in database partitions included in an approximate database partitioning arrangement, to respective selected ones of a plurality of certification algorithm executions; and
initiate certification, in parallel, of the transactions on the shared data stored in the database partitions, based on initiating the plurality of certification algorithm executions in parallel, and providing a sequential certifier effect,
the plurality of certification algorithm executions including a first certification algorithm execution that is configured to certify a first set of transactions that each access shared data that is stored in a plurality of the database partitions, and a plurality of second certification algorithm executions that are each configured to certify transactions that each access shared data that is stored in a single associated one of the database partitions.

18. The computer program product of claim 17, wherein the executable code is configured to cause the at least one data processing apparatus to:
initiate logging operations associated with a plurality of log partitions configured to store transaction objects associated with each respective transaction, wherein each respective database partition included in the approximate database partitioning is associated with one or more of the log partitions, wherein the logging operations are based on mapping the transaction objects to respective log partitions corresponding to respective database partitions accessed by respective transactions associated with the respective mapped transaction objects, wherein the transaction objects are associated with transaction certification ordering attributes, wherein:
initiating certification of the transactions on the shared data stored in the database partitions is based on receiving certification requests from a scheduler, and based on the transaction certification ordering attributes, and based on accessing the transaction objects stored in the log partitions, in an ordering of storage in the respective log partitions.

19. The computer program product of claim 17, wherein the executable code is configured to cause the at least one data processing apparatus to:
initiate logging operations associated with a log configured to store transaction objects associated with each respective transaction, wherein the logging operations are based on mapping the transaction objects to the log, and based on transaction certification ordering attributes associated with each respective transaction object, wherein:
initiating certification of the transactions on the shared data stored in the database partitions is based on receiving certification requests from a scheduler, and based on the transaction certification ordering attributes, and based on accessing the transaction objects stored in the log, in an ordering of storage in the log.

20. The computer program product of claim 17, wherein:
the first certification algorithm execution includes a multi-partition certification algorithm execution that is configured to certify the first set of transactions that access the shared data that is stored in the plurality of the database partitions, and plurality of second certification algorithm executions includes a set of single-partition certification algorithm executions, that are each configured to certify the transactions that access the shared data that is stored in the single associated one of the database partitions, wherein
assigning the each of the plurality of transactions includes assigning the each of the plurality of transactions to the respective selected ones of the certification algorithm executions, based on determining shared data access attributes associated with the respective transactions.
